(19) United States
(12) Patent Application Publication
(10) Pub. No.: US 2021/0168719 A1
(43) Pub. Date: Jun. 3, 2021

(54) MODIFYING WAKE UP SIGNALING STATE OF A WIRELESS TERMINAL

(71) Applicant: SHARP KABUSHIKI KAISHA, Sakai City, Osaka (JP)

(72) Inventors: EDWARD MASAMI SUGIYAMA, Vancouver, WA (US); JIA SHENG, Vancouver, WA (US)

(21) Appl. No.: 17/263,473

(22) PCT Filed: Aug. 6, 2019
(86) PCT No.: PCT/JP2019/030951

§ 371 Date: Jan. 26, 2021

Related U.S. Application Data
(60) Provisional application No. 62/716,777, filed on Aug. 9, 2018.

(51) Int. Cl. H04W 52/02; H04W 68/00

(52) U.S. Cl. CPC H04W 52/0229; H04W 68/005; H04W 52/0235; H04W 52/0216

(57) ABSTRACT

The wake up signaling state of a wireless terminal is controlled for selective enablement and disablement.

### CROSS REFERENCE

This Nonprovisional application claims priority under 35 U.S.C. § 119 on provisional Application No. 62/716,777 on Aug. 9, 2018, the entire contents of which are hereby incorporated by reference.

### TECHNICAL FIELD

The technology relates to wireless communications, and particularly to wake up signaling for a wireless terminal.

### BACKGROUND ART

A wireless terminal, also known as a mobile station, mobile terminal, user equipment, or more simply “UE”, typically communicates across an air or radio interface either with a radio access network or, in some instances, another wireless terminal. The radio access network generally comprises one or more access nodes, such as a base station node. In some more recent technologies the base station has also been referred to as an eNodeB, eNB, or gNB. Nodes of the radio access network are typically in turn connected to nodes of a core network.

In some instances in which a network, or a wireless terminal which is initiating a communication, seeks to contact a potential receiving wireless terminal, a paging message is sent to the wireless terminal through the network. In order to monitor for a possible incoming paging message, the potentially receiving wireless terminal should be in a mode of monitoring for a paging message. But since a paging message monitoring mode requires a relatively increased level for the wireless terminal, the wireless terminal would prefer to be in a lower power level and notified when the wireless terminal should be in a paging message monitoring mode. For this reason a wireless terminal typically operates at a lower power level than the paging message mode. In order to enter a paging message mode, the wireless terminal typically receives certain wake up signaling, WUS, which indicates to the wireless terminal that the wireless terminal should enter the paging message monitoring mode. But the process of monitoring for the wake up signaling itself also has involves a certain degree of power consumption by the wireless terminal.

Wake up signaling and other aspects of wireless terminal and telecommunication network operation have, to some degree, been standardized by the 3rd Generation Partnership Project (“3GPP”). The 3GPP standard is a collaboration agreement that aims to define globally applicable technical specifications and technical reports for differing generation wireless communication systems.

For example, wake up signaling has been defined by 3GPP as a feature useful for conserving power of Cellular Internet of Things (CIoT), which may include enhanced Machine-Type Communication (eMTC) and Narrow Band IoT (NB-IoT) devices. If the core network, specifically Mobility Management Entity (MME) desires to page a wireless terminal/user equipment (UE), a WUS is transmitted by the base station/substation (BS) to alert the UE of an incoming paging message. Once a WUS is detected, the UE starts the monitoring process NB-IoT Physical Downlink Control Channel (NPDCCH) for paging message.

Currently, in 3GPP proposed solutions for enabling or disabling WUS include the following:
Broadcasting System Information (SI) is used to enable/disable wake up signaling. If wake up signaling function is supported, the wireless terminal can modify the state of wake up signaling after acquisition of SI. However, to read the SI message, the UE requires access to the eNB/gNB. In some cases, the SI update procedure may not occur for a long period because the UE is in sleep mode.
WUS state information is in the NPDCCH paging message. This solution uses lower layer (MAC CE or DCI), and hence SI acquisition is not needed to update the state of WUS function. While this solution eliminates need for SI acquisition, the new WUS state is not known until the next paging cycle or WUS signal. As a result, the UE still needs to monitor for WUS.

Maximum battery life is achieved by disabling the wake up signaling detector in the wireless terminal. The disadvantage with this solution is that disabling wake up signaling also compromises reachability of the wireless terminal.

Examples of 3GPP documents, and other documents, which at least partially concern wake up signaling include the following (all of which are incorporated herein by reference in their entirety):
R2-1806134, 3GPP TSG-RAN WG2 Meeting #101bis, Sanya, China, 16 Apr.-20 Apr. 2018, Consideration of WUS enabled and disabled
Tdoc R2-1807097, 3GPP TSG RAN WG2 #102, Busan, South Korea, 21-25 May 2018, Report of email discussion to progress open issues on WUS.
R2-1804962, 3GPP TSG-RAN2 Meeting #101bis, Sanya, China, 16-20 Apr. 2018, Wake Up Signal OSDI model layers
US Patent publication US20150173039A1, entitled “UE Wake-up Ahead of Paging Occasions to Retrieve Paging Configuration Information when in (Long) DRX”
US Patent publication US20170013553A1, entitled “Wakeup method for devices in power saving mode”

As mentioned above, the process of monitoring for the wake up signaling also has involves a certain degree of power consumption by the wireless terminal. What is needed, therefore, are methods, apparatus, and/or techniques for managing, controlling, or limiting the power required or expended by a wireless terminal for processing or handling wake up signaling.

### SUMMARY OF INVENTION

In one example, a wireless terminal which communicates over a radio interface with a radio access network, the wireless terminal comprising: receiver circuitry configured to obtain, in a message received over the radio interface in a case that the wireless terminal is in a connected mode, an indication from a core network of a commanded wake up signaling state for the wireless terminal; processor circuitry configured to manage a current wake up signaling state of the wireless terminal in the connected mode as being either in an enable wake up signaling state or a disable wake up signaling state in dependence upon the commanded wake up signaling state indicated by the core network.

In one example, a method in a wireless terminal which communicates over a radio interface with a radio access network, the method comprising: obtaining, in a message received over the radio interface in a case that the wireless terminal is in a connected mode, an indication from a core network of a commanded wake up signaling state for the wireless terminal; using processor circuitry to manage a current wake up signaling state of the wireless terminal in the connected mode as being either in an enable wake up signaling state or a disable wake up signaling state in dependence upon the commanded wake up signaling state indicated by the core network.

In one example, a node of a core network of a telecommunications system, the core network node comprising: processor circuitry configured to include an indication of a commanded wake up signaling state for a wireless terminal in a message, the commanded wake up signaling state being either an enable wake up signaling state or a disable wake up signaling state; interface circuitry configured to transmit the message to a radio access network which serves the wireless terminal.

In one example, a method in a node of a core network of a telecommunications system, the method comprising: using processor circuitry to include an indication of a commanded wake up signaling state for a wireless terminal in a message, the commanded wake up signaling state being either an enable wake up signaling state or a disable wake up signaling state; transmitting the message to a radio access network which serves the wireless terminal.

In one example, a method in a node of a core network of a telecommunications system, the method comprising: using processor circuitry to generate an indication of a commanded wake up signaling state for a wireless terminal in a message, the commanded wake up signaling state being either an enable wake up signaling state or a disable wake up signaling state; transmitting the message toward a radio access network which serves the wireless terminal.

### BRIEF DESCRIPTION OF DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view showing a generic architectural configuration of a radio communications system in which wake up signaling is implemented.

FIG. 2 is a diagrammatic view showing transition states of a Radio Resource Control RRC state machine.

FIG. 3 is a schematic view showing various example, representative, non-limiting components and functionalities pertinent of a generic wireless terminal which performs wake up signaling state operations in a connected mode, as well as select details of other aspects of communication system.

FIG. 4 is a signal flow diagram showing example signals or messages between a wireless terminal and a CIoT application server in a system such as FIG. 3, including connection setup.

FIG. 5A is a flowchart showing, basic, representative, non-limiting acts or steps comprising generic methods of operation of a CIoT application server of FIG. 3.

FIG. 5B is a flowchart showing, basic, representative, non-limiting acts or steps comprising generic methods of operation of a CIoT application server of FIG. 3.

FIG. 6 is a flowchart showing, basic, representative, non-limiting acts or steps comprising a generic method of operation of a mobility management entity (MME) of FIG. 3.

FIG. 7A is a flowchart showing, basic, representative, non-limiting acts or steps comprising generic methods of operation of a connected mode-operative wake up signaling state controller of FIG. 3.

FIG. 7B is a flowchart showing, basic, representative, non-limiting acts or steps comprising generic methods of operation of a connected mode-operative wake up signaling state controller of FIG. 3.

FIG. 8 is a flowchart showing basic, example, representative acts of steps performed by a wireless terminal upon wake up signaling detection enablement and for receiving a paging message.

FIG. 9A is a signaling diagram which illustrate example of differing methods of transmitting the wake up signaling state from a CIoT application server to the connected mode wireless terminal of FIG. 3.

FIG. 9B is a signaling diagram which illustrate example of differing methods of transmitting the wake up signaling state from a CIoT application server to the connected mode wireless terminal of FIG. 3.

FIG. 9C is a signaling diagram which illustrate example of differing methods of transmitting the wake up signaling state from a CIoT application server to the connected mode wireless terminal of FIG. 3.

FIG. 9D is a signaling diagram which illustrate example of differing methods of transmitting the wake up signaling state from a CIoT application server to the connected mode wireless terminal of FIG. 3.

FIG. 10 is a schematic view showing various example, representative, non-limiting components and functionalities pertinent of a generic wireless terminal which performs wake up signaling state operations using unilateral wake up signaling state information, as well as select details of other aspects of communication system.

FIG. 11 is a flowchart showing, basic, representative, non-limiting acts or steps comprising a generic method of operation of a unilateral operational wake up signaling state controller of FIG. 10.

FIG. 12 is a flowchart showing, basic, representative, non-limiting acts or steps comprising a generic method of operation of a network node that includes unilateral operational wake up signal in a message for a wireless terminal.

FIG. 13A is a timing diagram showing differ way of expressing or representing the configured duration of how long wake up signaling detection is to remain active upon receipt of a unilateral wake up signaling state information.

FIG. 13B is a timing diagram showing differ way of expressing or representing the configured duration of how long wake up signaling detection is to remain active upon receipt of a unilateral wake up signaling state information.

FIG. 13C is a timing diagram showing differ way of expressing or representing the configured duration of how long wake up signaling detection is to remain active upon receipt of a unilateral wake up signaling state information.

FIG. 13D is a timing diagram showing differ way of expressing or representing the configured duration of how long wake up signaling detection is to remain active upon receipt of a unilateral wake up signaling state information.

FIG. 14A is a schematic view showing differing way of provided configured duration parameter to a wireless terminal.

FIG. 14B is a schematic view showing differing way of provided configured duration parameter to a wireless terminal.

FIG. 15A is a timing diagram showing differ way of expressing or representing the configured duration of how long wake up signaling detection is to remain disabled upon receipt of a unilateral wake up signaling state information.

FIG. 15B is a timing diagram showing differ way of expressing or representing the configured duration of how long wake up signaling detection is to remain disabled upon receipt of a unilateral wake up signaling state information.

FIG. 15C is a timing diagram showing differ way of expressing or representing the configured duration of how long wake up signaling detection is to remain disabled upon receipt of a unilateral wake up signaling state information.

FIG. 15D is a timing diagram showing differ way of expressing or representing the configured duration of how long wake up signaling detection is to remain disabled upon receipt of a unilateral wake up signaling state information.

FIG. 16 is a schematic view showing various example, representative, non-limiting components and functionalities pertinent of a generic wireless terminal which performs wake up signaling state operations using bilateral wake up signaling state information obtained from a medium access control (MAC) control element (CE).

FIG. 17 is a flowchart showing example, representative, basic acts or steps performed by a wireless terminal of FIG. 16.

FIG. 18 is a schematic view showing various example, representative, non-limiting components and functionalities pertinent of a generic wireless terminal which performs wake up signaling state operations using bilateral wake up signaling state information obtained from broadcasted system information.

FIG. 19 is a flowchart showing example, representative, basic acts or steps performed by a wireless terminal of FIG. 18.

FIG. 20 is a schematic view showing various example, representative, non-limiting components and functionalities pertinent of a generic wireless terminal which performs wake up signaling state operations using bilateral wake up signaling state information obtained from paging downlink control information.

FIG. 21 is a flowchart showing example, representative, basic acts or steps performed by a wireless terminal of FIG. 20.

FIG. 22 is a schematic view showing various example, representative, non-limiting components and functionalities pertinent of a generic wireless terminal which performs wake up signaling state operations using bilateral wake up signaling state information obtained from a one or more of medium access control (MAC) control element (CE), broadcasted system information, and paging downlink control information.

FIG. 23 is a flowchart showing example, representative, basic acts or steps performed by a wireless terminal of FIG. 22.

FIG. 24 is diagrammatic view of a matrix showing possible combinations of signal sources and signal types for the wake up signaling detection enablement signal and the wake up signaling detection disablement signal for the example embodiment of FIG. 22.

FIG. 25 is a schematic view showing various example, representative, non-limiting components and functionalities pertinent of a generic wireless terminal which performs wake up signaling state operations using bilateral wake up signaling state information obtained from a message of a physical random access channel (PRACH) procedure.

FIG. 26 is a flowchart showing example, representative, basic acts or steps performed by a wireless terminal of FIG. 25.

FIG. 27 is a flowchart showing example, representative, basic acts or steps performed by a network node of FIG. 25.

FIG. 28 shows possible components and functionalities of a wireless terminal in various example embodiments and modes.

FIG. 29 is a diagrammatic view showing example elements comprising electronic machinery which may comprise a wireless terminal according to an example embodiment and mode.

### DESCRIPTION OF EMBODIMENTS

In various example embodiments and modes, the technology disclosed herein concerns apparatus and method for controlling a wake up signaling state of a wireless terminal, such as a CIoT device. The wake up signaling state is controlled for selective enablement and disablement, thereby controlling and preferably preserving power utilization for the wireless terminal. In some example embodiments and modes the wireless terminal is provided with a wake up signaling state controller which controls changing or modifying the wake up signaling state of the wireless terminal when the wireless terminal is in a connected mode. The CIoT application server 60 may receive enable wake up signaling and disable wake up signaling from a network node, such as a CIoT application server. The CIoT application server 60 may determine when to send an indication of a commanded wake up signaling state, e.g., either to enable the wake up monitoring or disable the wake up monitoring by the wireless terminal. Such indication may be generated based on analysis by the network node of uplink data obtained from the wireless terminal in connected mode.

In other example embodiments and modes the wireless terminal need not be in connected mode, but may be in other radio resource control modes such as RRC Idle mode.

In some example embodiments and modes the wireless terminal may receive a unilateral type of wake up signaling, e.g., only an enable wake up signaling for enabling wake up signaling detection, or only disable wake up signaling, for disabling wake up detection.

In some example embodiments and modes the wireless terminal may receive bilateral wake up signaling, e.g., both an enable wake up signaling for enabling wake up signaling detection and disable wake up signaling, for disabling wake up detection. The enable wake up signaling and the disable wake up signaling may be delivered by the same source or same type of messaging, or by differing types of messages or from differing messaging sources.

The technology disclosed herein concerns not only wireless terminals and methods for controlling or managing the wake up signaling detection, but also network nodes, e.g., nodes of a radio access network and a core network, which generate or transmit messages pertinent to the control of the wake up signaling detection, as well as methods of operation of such nodes.

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudo code, and the like represent various processes which may be substantially represented in computer readable medium and so executed by a computer or processor, whether or not such computer or processor is explicitly shown.

As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc.

As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc.

As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”), a gNB (for a New Radio [“NR” ] technology system), or some other similar terminology. Another non-limiting example of a base station is an access point. An access point may be an electronic device that provides access for wireless terminal to a data network, such as (but not limited to) a Local Area Network (“LAN”), Wide Area Network (“WAN”), the Internet, etc. Although some examples of the systems and methods disclosed herein may be described in relation to given standards (e.g., 3GPP Releases 8, 9, 10, 11, 12, 13, and thereafter), the scope of the present disclosure should not be limited in this regard. At least some aspects of the systems and methods disclosed herein may be utilized in other types of wireless communication systems.

As used herein, the term “telecommunication system” or “communications system” can refer to any network of devices used to transmit information. A non-limiting example of a telecommunication system is a cellular network or other wireless communication system.

As used herein, the term “cellular network” or “cellular radio access network” can refer to a network distributed over cells, each cell served by at least one fixed-location transceiver, such as a base station. A “cell” may be any communication channel that is specified by standardization or regulatory bodies to be used for International Mobile Telecommunications-Advanced (“IMTAdvanced”). All or a subset of the cell may be adopted by 3GPP as licensed bands (e.g., frequency band) to be used for communication between a base station, such as a Node B, and a UE terminal. A cellular network using licensed frequency bands can include configured cells. Configured cells can include cells of which a UE terminal is aware and in which it is allowed by a base station to transmit or receive information. Examples of cellular radio access networks include E-UTRAN, and any successors thereof (e.g., NUTRAN).

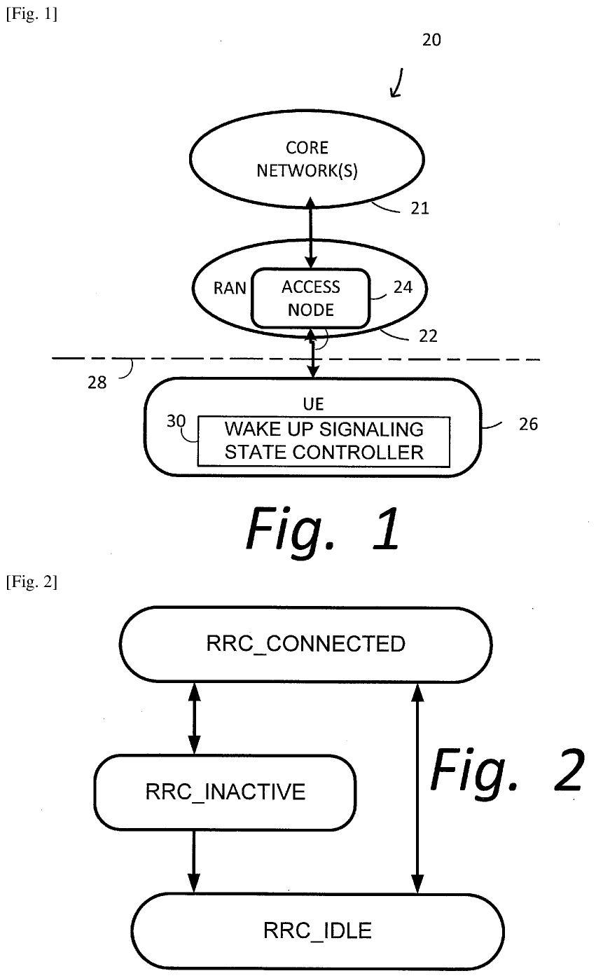

As illustrated by the high level generic view of FIG. 1, a typical radio communication system 20 comprises a core network 21; one or more radio access networks (RAN) 22 including one or more base stations or access nodes 24, and terminal devices used by the end users, represented by wireless terminal or UE 26. The access node 24 and the wireless terminal 26 communicate over an air or radio interface 28, which is also known as the Uu interface for LTE.

The Core Network (CN) 21 includes the central part of the radio communication system that provides various services to customers who are connected by the radio access network 22. The core network for the Global System for Mobile Communication (GSM) is called the GSM Network Switching Subsystem or NSS or the GSM core network; the core network for the Universal Mobile Telecommunications System (UMTS) is a migration of that used for GSM with further elements overlaid to enable the additional functionality demanded by UMTS and is called the UTMS core network; the core network in the 4G network is called Evolved Packet Core (EPC), and the core network in the 5G network is referred as 5G Core Network (5GC).

The Radio Access Network (RAN) 22 comprises, e.g., is a part of, a radio communication system that resides between terminal devices such as wireless terminal 26 and a core network 21. The RAN 22 provides connectivity to the devices through radio interfaces via the base station(s) or access node(s) 24, e.g., via eNB (in LTE/LTE-A RAN) or via gNB (in 5G RAN). The terminal devices 26 which are used by end users are also referred to as wireless terminals or User Equipment (UE). As used herein, the wireless terminal 26 may be an enhanced Machine-Type Communication (eMTC) device or a Narrow Band Internet of Things (NB-IoT) device.

Example embodiment and modes of the technology disclosed herein concern managing, controlling, or limiting the power required or expended by a wireless terminal for processing or handling wake up signaling. The ability to control the state of wake up signaling allows optimization of battery life. In a wireless terminal, power consumption for monitoring wake up signaling signal is lower than monitoring for paging messages (NPDCCH). However power savings can be extended further if wake up signaling detection is turned off, so that the wireless terminal 26 may transition to deep sleep mode in which wake up signaling detection is disabled. However, if wake up signaling detection is disabled, the wireless terminal is not reachable during sleep mode.

Example embodiments and modes described herein increase battery life of wireless terminal by, e.g., controlling a state (enable/disable) of the wake up signaling function, e.g., controlling a wake up signaling state. In a typical CIoT use case, a wireless terminal transmits Uplink (UL) data to the core network (CN) at some instances. In between UL transmissions, the wireless terminal will be in reduced battery usage mode determined by power saving features including extended idle-mode DRX (eDRX) and Power Savings Mode (PSM).

Accordingly, various example aspects of the technology disclosed herein concern management and control wake up signaling, such as activation and deactivation of wake up signaling reception for the wireless terminal 26. Such example aspects encompass modification of a wake up signaling state, e.g., changing from an enabled wake up signaling state to a disabled wake up signaling state, or conversely from a disabled wake up signaling state to an enabled wake up signaling state. As understood from the foregoing, when in an enabled wake up signaling state, the wireless terminal 26 turns on detection for wake up signaling, e.g., is permitted to monitor for a wake up signals. In response to receipt of a wake up signal the receiver circuitry is configured to monitor for receipt of a paging message. But when the current wake up signaling state is the disabled wake up signaling state the receiver circuitry does not monitor for the wake up signal, with the result that the user equipment operates with lower power than when configured to monitor for receipt of the wake up signal.

Thus, in representative and generic fashion, FIG. 1 shows that, in an example embodiment and mode, wireless terminal 26 may comprise wake up signaling state controller 30. The wake up signaling state controller 30 comprises a wake up signaling detector and keeps track of a current wake up signaling state. In keeping track of the current wake up signaling state, at an appropriate time may change the wake up signaling state. The change of the wake up signaling state may result upon receipt of a command to change the wake up signaling state, or as a result of expiration of a time window or timer or the like.

In some example embodiments and modes described herein, the wake up signaling state controller 30 serves to enable or disable the wake up signaling while wireless terminal 26 is in a connected mode. In various such connected mode example embodiments and modes, certain higher layer messaging or signaling is utilized to carry an indication of a commanded wake up signaling state for the user equipment. Such higher layer messaging or signaling may be generated by a core network, e.g., a core network node, as described herein. In some example implementations, the core network may generate the indication of a commanded wake up signaling state based on uplink data transmissions from the wireless terminal 26. For example, as described in certain connected mode example embodiments and modes herein, UL data may eventually reach an Application Server in the core network where the UL data is processed. The Application Server may analyze UL data coming from multiple wireless terminals. The Application Server may respond back to the wireless terminal with information to enable or disable wake up signaling while still in connected mode. The ability to enable/disable wake up signaling during connected state allows immediate enabling/disabling of WUS function and thus optimizes battery life.

In other example embodiments and modes the wireless terminal 26 need not be in the connected mode to receive wake up signaling, e.g., need not be in the connected mode to receive an indication of a commanded wake up signaling state for the user equipment.

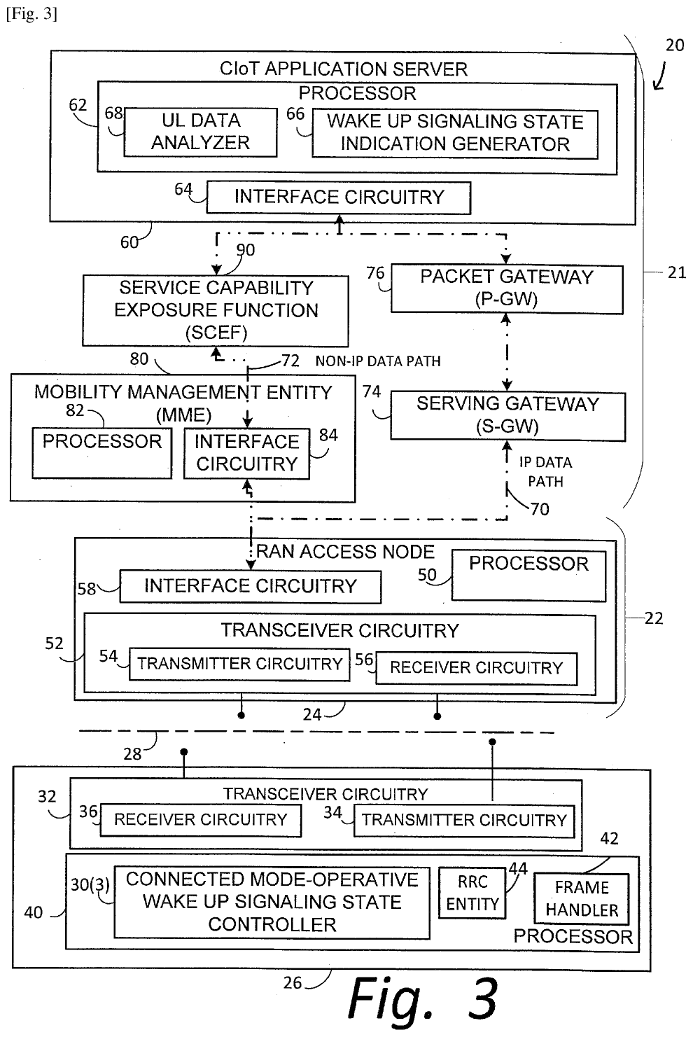

Since, in at least some example embodiments and modes, the wake up signaling state controller 30 is capable of operating in the connected mode, a brief description of radio resource control (RRC) and the connected mode ensues. As described herein, both an access node and a wireless terminal may manage a respective Radio Resource Control (RRC) state machines. The RRC state machines transition between several RRC states including RRC_IDLE, RRC_INACTIVE and RRC_CONNECTED. FIG. 2 depicts the state transition diagram of the RRC states. From the vantage point of a wireless terminal e.g., user equipment (UE), the RRC states may be briefly characterized as follows:
RRC_IDLE:
   A UE specific DRX (discontinuous reception) may be configured by upper layers;
   UE controlled mobility based on network configuration;
   The UE:
      Monitors a Paging channel;
      Performs neighboring cell measurements and cell (re-)selection;
      Acquires system information.
RRC_INACTIVE:
   A UE specific DRX may be configured by upper layers or by RRC layer;
   UE controlled mobility based on network configuration;
   The UE stores the Access Stratum (AS) context;
   The UE
      Monitors a Paging channel;
      Performs neighboring cell measurements and cell (re-)selection;
      Performs RAN-based notification area updates when moving outside the RAN-based notification area;
      Acquires system information.
RRC_CONNECTED:
   The UE stores the AS context.
   Transfer of unicast data to/from UE.
   At lower layers, the UE may be configured with a UE specific DRX;
   Network controlled mobility, i.e. handover within NR and to/from E-UTRAN;
   The UE:
      Monitors a Paging channel;
      Monitors control channels associated with the shared data channel to determine if data is scheduled for it;
      Provides channel quality and feedback information;
      Performs neighboring cell measurements and measurement reporting;
      Acquires system information.

As used herein, a “layer” in the sense of “higher layer” and “lower layer” refers to one or more layers of the OSI model. As understood by those skilled in the art, the OSI model layers include (from lowest to highest) (1) the physical layer, (2) the data link layer, (3) the network layer, (4) the transport layer, (5) the session layer, (6) the presentation layer, and (7) the application layer. As used herein, “lower layer” refers to one or both of (1) the physical layer and (2) data link layer, so that any other layer is considered herein to be a higher layer.

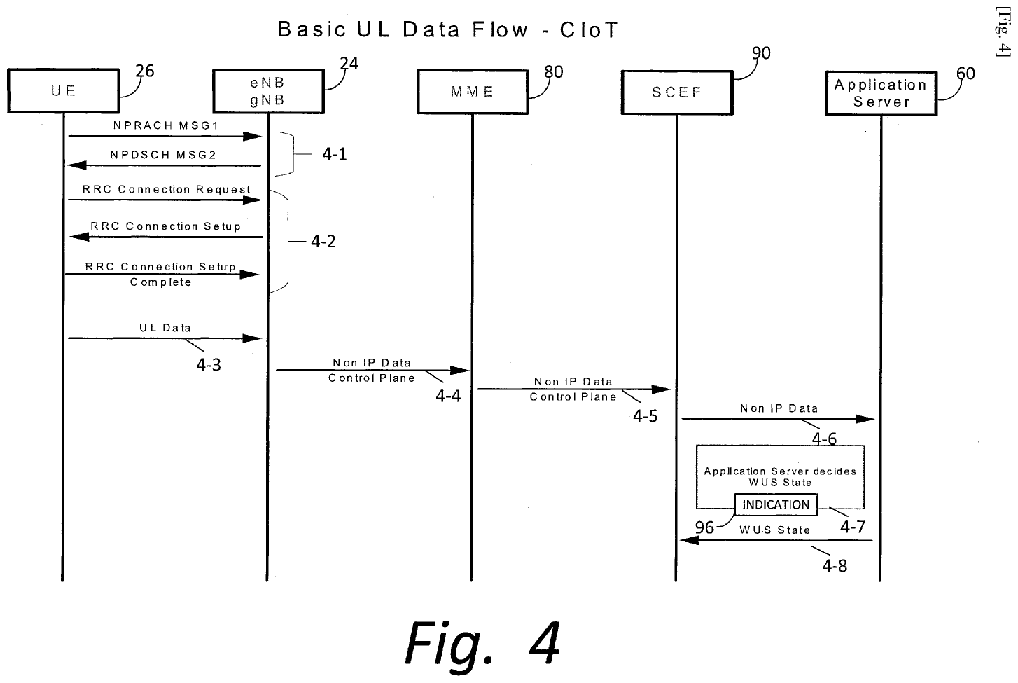

FIG. 3 shows various example, representative, non-limiting components and functionalities herein pertinent of a generic wireless terminal 26 which comprises a connected mode-operative wake up signaling state controller 30(3), as well as select details of other aspects of communication system 20. The wireless terminal 26 comprises terminal transceiver circuitry 32, which in turn comprises terminal transmitter circuitry 34 and terminal receiver circuitry 36. The transceiver circuitry 32 includes antenna(e) for the wireless terminal 26. Transmitter circuitry 34 includes, e.g., amplifier(s), modulation circuitry and other conventional transmission equipment. Receiver circuitry 36 comprises, e.g., amplifiers, demodulation circuitry, and other conventional receiver equipment. The transceiver circuitry 32 is configured to use resources for communication with a radio access network 22, such as E-UTRAN network 30 and/or New Radio 5G network 32.

The user equipment 26 further comprises processor circuitry, also herein known more simply as UE processor 40, or simply as processor 40. While processor 40 may have responsibility for operation of many aspects of wireless terminal 26 not specifically described herein, in one of its aspects processor 40 serves as wake up signaling state controller 30 for controlling aspects of the wake up signaling. The processor 40 may also comprise, or work in conjunction with frame handler 42 and radio resource control (RRC) entity 44. The radio resource control (RRC) entity 44 operates as the RRC state machine described above, e.g., with reference to FIG. 2, and, among other functions, notifies the connected mode-operative wake up signaling state controller 30(3) when the wireless terminal 26 is in the connected mode

As mentioned above, radio access network (RAN) 22 comprises one or more access nodes, one such access node 24 being shown in FIG. 3. As indicated above, depending on radio access technology and generation, the access node 24 may have any of several names, and accordingly, as shown in FIG. 1, may be referred to as an eNodeB, e.g., eNB, or, for 5G or New Radio, as gNB. The access node 24 comprises node processor circuitry, simply referred to as node processor 50, as well as access node transceiver 52. The access node transceiver 52 comprises node transmitter circuitry 54 and node receiver circuitry 56. Since the access node transceiver 52 communicates over radio interface 28 with wireless terminal 26, the structure and function of node transmitter circuitry 54 and node receiver circuitry 56 are understood with respect to comparable structure and function of terminal transceiver circuitry 32. The access node 24 also comprises node interface circuitry 58 for communicating with core network 21.

The core network 21 is shown in more detail in FIG. 3 as comprising application server 60. The application server 60 may serve as an application server for CIoT devices, such as eMTC and NB-IoT devices, and thus for sake of convenience only is labeled in FIG. 3 as CIoT application server 60. It should be understood that application server 60 may be referred to by other names, and that application server 60 may stand alone as one or more distinct nodes of core network 21, or be included with or subsumed in one or more other nodes of core network 21 which serve other or additional functions. The CIoT application server 60 may analyze data for CIoT devices. Multiple wireless terminals, e.g., multiple CIoT devices, may be connected to a single CIoT application server 60.

As shown in FIG. 3, CIoT application server 60 comprises application server processor circuitry, e.g., application server processor 62, and application server interface circuitry 64. The application server processor 62 comprises, among other possible functionalities, wake up signaling state indication generator 66 and uplink data analyzer 68. As explained herein, wake up signaling state indication generator 66 generates an indication, such as a flag, which is employed to change the wake up signaling state of wireless terminal 26 to a commanded state, e.g., to either the enabled wake up signaling state or the disabled wake up signaling state, depending on the perception of CIoT application server 60 regarding the proper wake up signaling state in which wireless terminal 26 should now operate. The CIoT application server 60 develops it assessment of the proper wake up signaling state for wireless terminal 26 based on uplink (UL) data received from wireless terminal 26, as analyzed by uplink data analyzer 68.

Between radio access network (RAN) 22 and CIoT application server 60 there is both an IP data path 70 and a non-IP data path 72 through core network 21. IP data path 70 is shown by a dashed/single dotted line in FIG. 3; the non-IP data path 72 is shown by a dashed/double dotted line in FIG. 3. For the IP data path 70, the node interface circuitry 58 of access node 24 connects to serving gateway (S-GW) 74, which in turn connects to packet gateway (P-GW) 76. The packet gateway (P-GW) 76 connects to application server interface circuitry 64.

The non-IP data path 72 is employed for non-IP data delivery (NIDD). For the non-IP data path 72, the node interface circuitry 58 of access node 24 connects to mobility management entity (MME) 80. The mobility management entity (MME) 80 comprises, e.g., MME processor circuitry 82 and MME interface circuitry 84. The MME interface circuitry 84 connects to node interface circuitry 58 of access node 24 and to Service Capability Exposure Function (SCEF) 90. The MME interface circuitry 84 is also connected to the application server interface circuitry 64 of CIoT application server 60.

Thus, in an example scenario, uplink data flow for FIG. 3 may be as follows: The wireless terminal 26 sends UL data to access node 24 (e.g., eNB/gNB); data packets are separated into Non IP and IP data, e.g., to non-IP data path 72 and IP data path 70. The non IP data is routed on non-IP data path 72 to Mobility Management Entity (MME) 60, to Service Capability Exposure Function (SCEF) 90, and then to CIoT application server 60. The IP data is routed on IP data path 70 via serving gateway (S-GW) 74 and packet gateway (P-GW) 76 too CIoT application server 60.

The Service Capability Exposure Function (SCEF) 90 may comprise one or more stand-alone or dedicated node(s), or may comprise or be subsumed in another node of core network 21. The role of SCEF (Service Capability Exposure Function) 90 is basically defined in 3GPP 23.682) Non-IP Data Delivery (NIDD) using Service Capability Exposure Function (SCEF). The contents of NIDD may include data from devices such sensor readings, location and more. The data is processed by the CIoT application server 60. One of the SCEF features provides a means to access and expose network capabilities. Network capabilities may include: Group message delivery, Monitoring of events, Resource management of background data transfer, and Network parameter configuration. The functions of Service Capability Exposure Function (SCEF) 90 may be performed by, e.g., executed on, processor circuitry of the node that hosts Service Capability Exposure Function (SCEF) 90. The Service Capability Exposure Function (SCEF) 90 is connected to non-IP data path 72 to application server interface circuitry 64 of CIoT application server 60. In this regard, a T6a/T6b connection may be used between Service Capability Exposure Function (SCEF) 90 and CIoT application server 60.

While uplink data transfer has been described above, it should also be mentioned that network parameter information is transferred on a downlink, e.g., in a direction from CIoT application server 60 to Service Capability Exposure Function (SCEF) 90. A network parameter transferred on the downlink (DL) which is particularly germane for the technology disclosed herein is the wake up signaling state, e.g., an indication of a commanded wake up signaling state. As described herein, the indication of a commanded wake up signaling state is determined by CIoT application server 60, e.g., by wake up signaling state indication generator 66. The indication of a commanded wake up signaling state is transferred from CIoT application server 60 to mobility management entity (MME) 80 via Service Capability Exposure Function (SCEF) 90. If both the network and UE support wake up signaling, the mobility management entity (MME) 80 is responsible for transporting wake up signaling state to the wireless terminal 26.

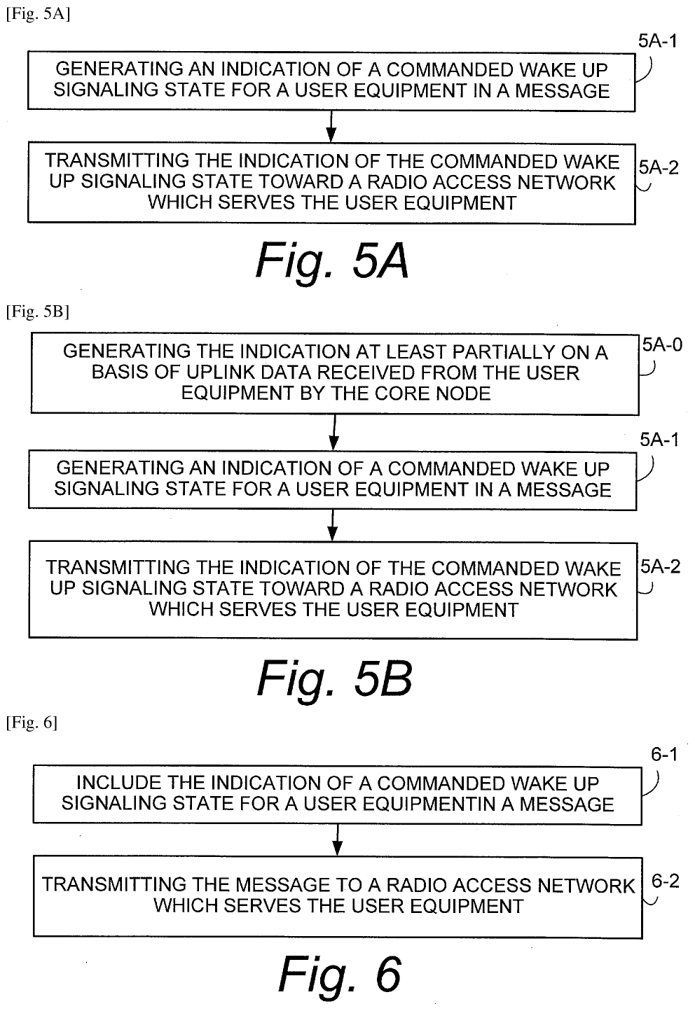

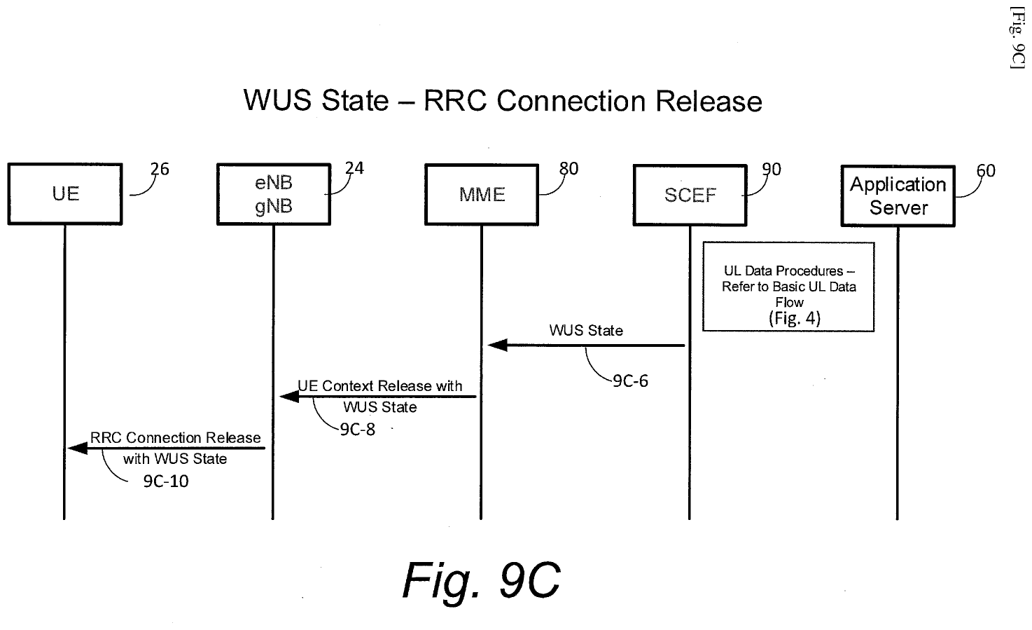

FIG. 4 shows signal flow between wireless terminal 26 and CIoT application server 60 in a system such as FIG. 3, including connection setup. The NPRACH Msg1 and NPDSCH Msg2 are included in a random access procedure 4-1. After access is granted, a RRC connection setup procedure 4-2 is performed, thereby rendering wireless terminal 26 in connected mode. After the connection is setup, the wireless terminal 26 may send uplink data to the access node 24 as reflected by act 4-3. The Non-IP data is routed from access node 24 to mobility management entity (MME) 80, as reflected by act 4-4, from mobility management entity (MME) 80 to Service Capability Exposure Function (SCEF) 90, as reflected by act 4-5, and from Service Capability Exposure Function (SCEF) 90 to CIoT application server 60 as reflected by act 4-6. Thereafter, as act 4-7, the CIoT application server 60 decides a wake up signaling state for the wireless terminal 26. The decision of the wake up signaling state may be based on the uplink data received as act 4-6 from the wireless terminal 26. After making the decision, the CIoT application server 60 sends an indication 96 of the decision, e.g., an indication 96 of a commanded wake up signaling state, on the downlink to wireless terminal 26 as reflected by act 4-8. Act 4-8 in particular shows the transmission of the indication of a commanded wake up signaling state from CIoT application server 60 to Service Capability Exposure Function (SCEF) 90. How the indication of a commanded wake up signaling state is further transmitted through core network 21 and radio access network (RAN) 22 is further described herein with respect to differing example implementations, such as the example methods of FIG. 9A through and including FIG. 9D. The acts of FIG. 4 are thus understood to precede the acts of the subsequently described methods of FIG. 9A-FIG. 9D.

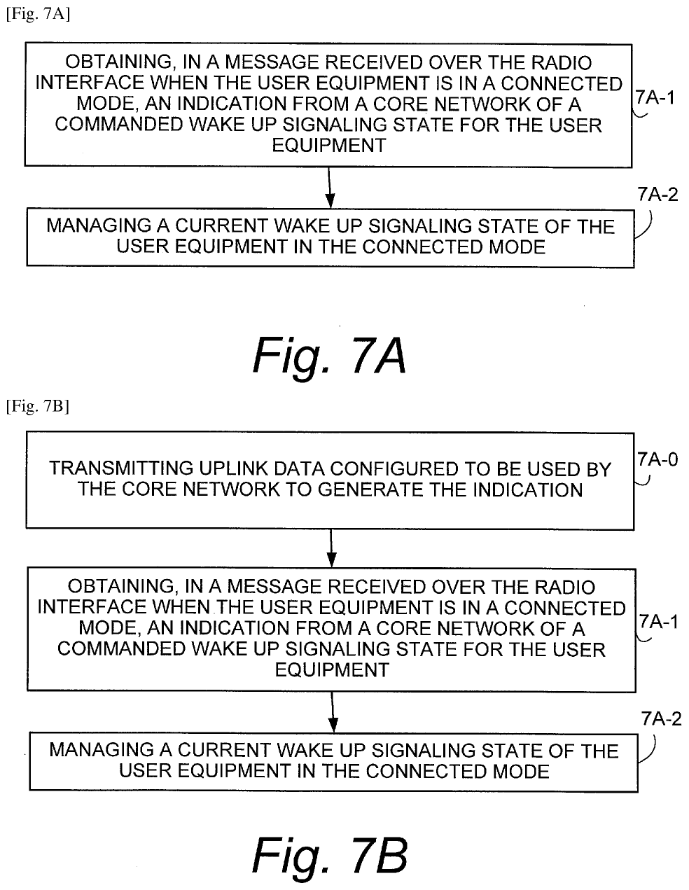

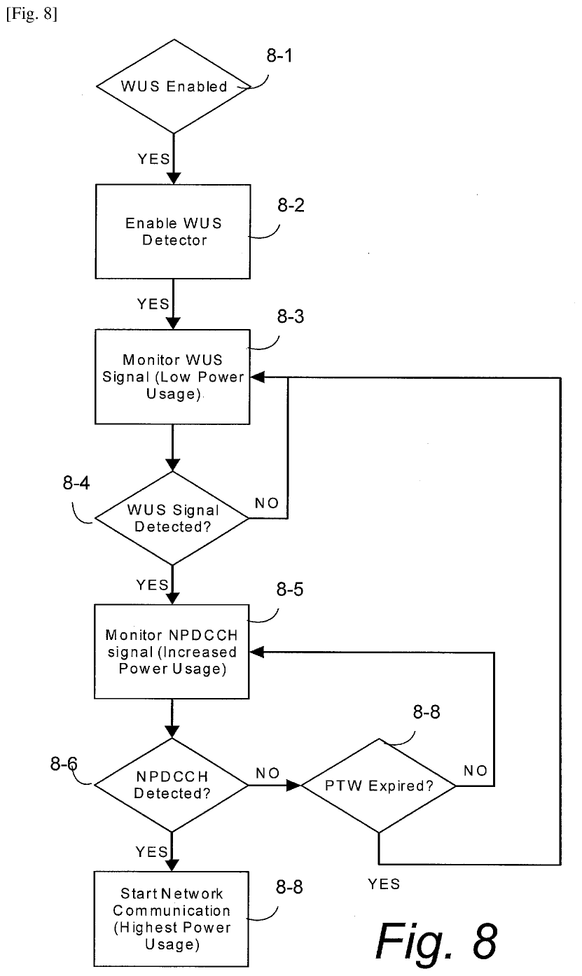

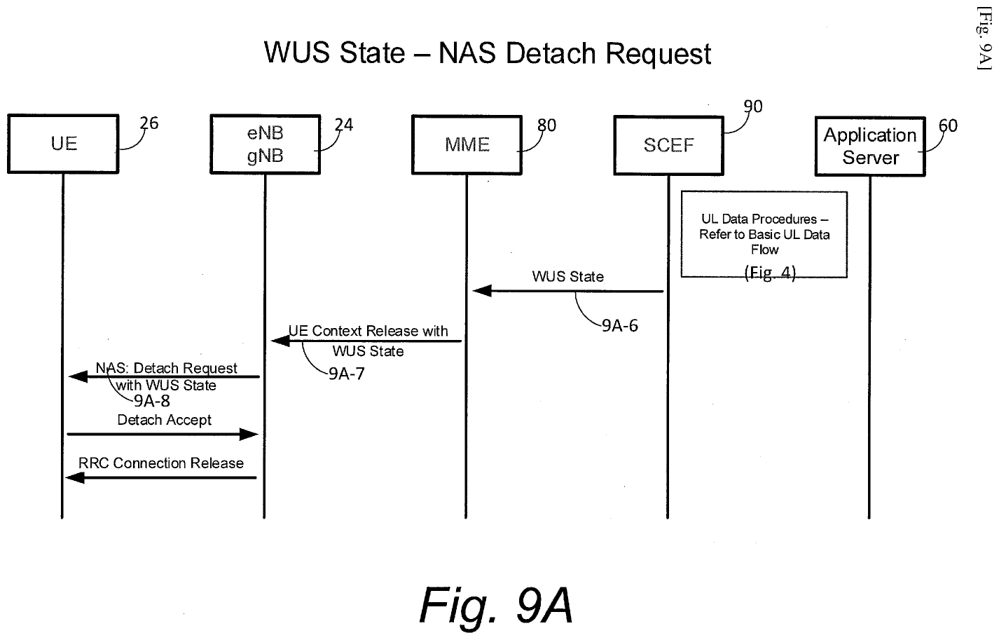

Generic, basic modes of operation for various devices and entities illustrated in FIG. 3 is shown in FIG. 5A and FIG. 5B, FIG. 6, and FIG. 7A and FIG. 7B. For example, FIG. 5A and FIG. 5B show basic modes of operation of CIoT application server 60; FIG. 6 shows a basic mode of operation of mobility management entity (MME) 80; and FIG. 7A and FIG. 7B show basic modes of operation of connected mode-operative wake up signaling state controller 30(3).

FIG. 5A shows basic acts involved in a generic mode of operation of CIoT application server 60 of FIG. 3. Act 5-1 comprises using processor circuitry, e.g., wake up signaling state indication generator 66 of application server processor 62, to generate an indication of a commanded wake up signaling state for a user equipment in a message. The indication generated as act 4A-1 of FIG. 5 is represented by indication 96. The indication 96 may be, for example, a flag. As indicated above, the commanded wake up signaling state is either an enable wake up signaling state or a disable wake up signaling state. Act 5-2 comprises transmitting the indication of the commanded wake up signaling state toward a radio access network which serves the user equipment. The transmission of act 5-2 may be performed by application server interface circuitry 64. FIG. 3 represents a communication from application server interface circuitry 64 that bears the indication 96.

FIG. 5B shows a variation of the basic generic mode of FIG. 5A, which further includes, as act 5-0 the CIoT application server 60, and particularly wake up signaling state indication generator 66, generating the indication 96 at least partially on a basis of uplink data received from the user equipment by the core node. For act 5-0, the uplink data from wireless terminal 26(3) is received on IP non-data path 72. The analysis of the uplink data from the wireless terminal 26 is performed by uplink data analyzer 68. The uplink data analyzer 68 determines the content of the indication 96, e.g., the indication of commanded wake up signaling state, based on uplink data received from the connected mode wireless terminal, and may do so using an algorithm or logic or rules which are appropriate for a function performed by or application executed by the wireless terminal. The uplink data which serves as the basis for the analysis may be, for example, data that is gathered or collected by or at the wireless terminal in conjunction with one or more operations performed by the wireless terminal, such as sensing or measurement, for example. In other words, the uplink data that is used by uplink data analyzer 68 to determine the desired wake up signaling state for the wireless terminal may, in at least some non-limiting example embodiments and modes, be data that is only obtainable in a connected mode of the wireless terminal. As a non-limiting example, CIoT devices may be implanted in an animal such as milking cows. The CIoT measures vital signals, e.g., temperature, heart rate, and others and may be used to determine optimum time for maximum milk production. The UL data comprising vital signs and other data from the CIoT device may be analyzed by the Application Server, e.g., by uplink data analyzer 68, using rules or algorithms that are pertinent to the task and/or environment of the CIoT. To save battery, the uplink data analyzer 68 of CIoT application server 60 may, for example, determine that the data indicates that no vital signals are required for a while, and hence the CIoT application server 60 may issue a command to disable the wake up signaling detection to conserve battery. On the other hand, the CIoT application server 60 may also conclude that more data or an action by CIoT device is be necessary, and hence the CIoT application server 60 may request that wireless terminal 26 to be on alert, e.g., with enabled wake up signaling detection, in order to be ready to monitor for paging messages. The technology disclosed herein is not limiting to monitoring of animals, or to monitoring per se, the foregoing serving instead primarily to provide an example of the uplink (UL) data and analysis thereby for generation of an indication of a commanded wake up signaling state.

FIG. 6 shows basic acts involved in a generic mode of operation of mobility management entity (MME) 80 of FIG. 3. Act 6-1 comprises using processor circuitry to include the indication of a commanded wake up signaling state for a user equipment, e.g., indication 96, in a message, such as generic message 98. As previously explained, the commanded wake up signaling state is either an enable wake up signaling state or a disable wake up signaling state. Act 6-1 may be performed by MME processor circuitry 82, after MME processor circuitry 82 receives the indication 96 of the commanded wake up signaling state from CIoT application server 60 via MME interface circuitry 84. Examples of the types of messages in which the mobility management entity (MME) 80 may include the indication 96 are discussed below with reference to FIG. 9A-FIG. 9D. Act 6-2 comprises the mobility management entity (MME) 80 transmitting the message 98 to a radio access network 22 which serves the user equipment. Such transmission of message 98 to radio access network 22 may occur using the MME interface circuitry 84.

An access node of radio access network 22, such as access node 24 of FIG. 3, receives the message 98 from mobility management entity (MME) 80 that bears the indication 96 of the commanded wake up signaling state. The node interface circuitry 58 receives the indication-bearing message 98, which is essentially relayed by node transmitter circuitry 54 over the radio interface 28 to wireless terminal 26.

FIG. 7A shows basic acts involved in a generic mode of operation of wireless terminal 26 of FIG. 3, e.g., a wireless terminal 26 that includes connected mode-operative wake signaling state controller 30(3). As mentioned above, the wireless terminal 26 may be an enhanced machine-type communication device or a narrow band Internet of Things device, but could also be other types of wireless terminals as well. Act 7-1 comprises the wireless terminal 26 obtaining, in a message received over the radio interface when the user equipment is in a connected mode, an indication from a core network of a commanded wake up signaling state for the user equipment. The message obtained in act 7-1 may be message 98 received over interface 28 from the radio access network, e.g., from access node 24. As indicated above, message 98 bears the indication of the commanded wake up signaling state. Act 7-2 comprises the wireless terminal 26 using processor circuitry, e.g., terminal processor 40, to manage a current wake up signaling state of the user equipment in the connected mode. In other words, the received indication 96 is used to put the wireless terminal 26, and connected mode-operative wake up signaling state controller 30(3) in particular, either in an enable wake up signaling state or a disable wake up signaling state in dependence upon the indication 96, e.g., independence on the commanded wake up signaling state indicated by the core network. The indication 96 borne by message 98 thus serves as the wake up signaling for wireless terminal 26.

FIG. 7B shows a variation of the basic generic mode of FIG. 7A, which further includes act 7-0. Act 7-0 comprises the wireless terminal 26 transmitting uplink data configured to be used by the core network to generate the indication 96. The nature of the data that is transmitted at act 7-0, and thus used by the core network to generate the indication 96, may be dependent upon a function performed by the wireless terminal or an environment or parameter sensed by the wireless terminal, for example.

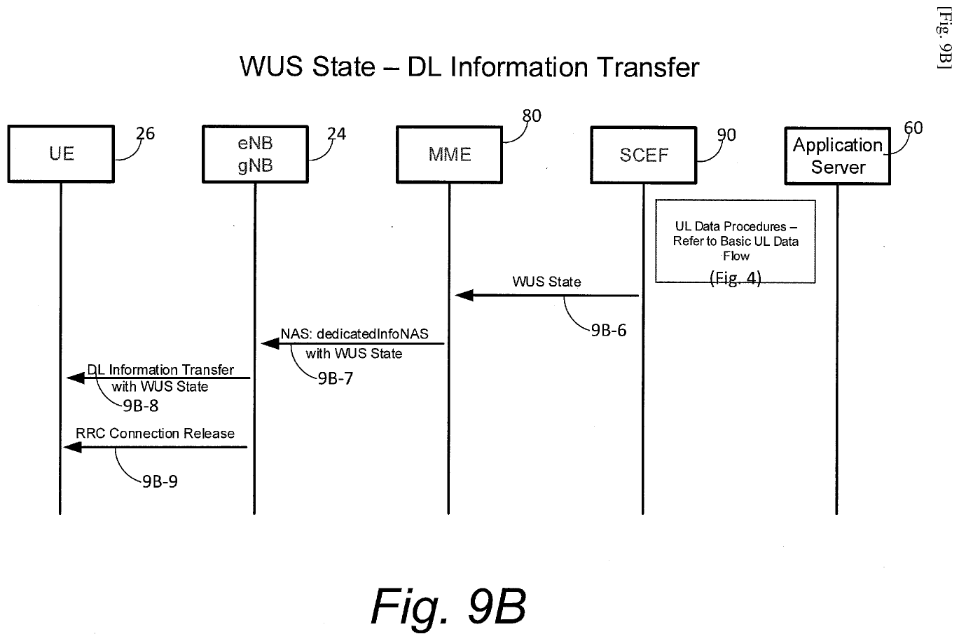

FIG. 8 shows example, representative acts of steps performed by a wireless terminal 26 of FIG. 3 after wake up signaling detection is enabled and when handling a paging operation. At least some of the acts of FIG. 8 may be performed by, or under control or direction of, the wake up signaling state controller 30. Act 8-1 comprises checking to determine if the wireless terminal has received an indication of a commanded wake up signaling state that commands enablement of the wake up signaling detection. If the determination of act 8-1 is affirmative, as act 8-2 the wake up signaling detector of connected mode-operative wake up signaling state controller 30(3) is enabled. Enablement of the wake up signaling detection increases power usage of the wireless terminal 26 from the very low power level of a deep sleep mode to the low power level of the wake up signaling state. Otherwise, if the determination of act 8-1 is negative, the wireless terminal 26 loops back to periodically repeat the determination of act 8-1 in case a subsequent commend is received.

After the wake up signaling detection is enabled at act 8-2, as act 8-3 the wake up signaling detector of state controller 30 monitors for an incoming wake up signal. In conjunction with such wake up signal monitoring, act 8-4 comprises determining if a wake up signal is detected. If no wake up signal is detected, execution loops back to the monitoring of act 8-3. If a wake up signal is detected at act 8-4, as act 8-5 the wireless terminal 26 monitors for a paging message. The operation of the paging monitoring requires increased power usage by the wireless terminal 26, e.g., a greater power level than the wake up signaling monitoring. For example act 8-5 may involve monitoring a particular paging channel, such as a narrowband physical downlink control channel (NPDCCH) for eMTC and NB-IoT devices. The NPDCCH is typically used to indicate UEs about their down link data (location, how often they are repeated, modulation and coding scheme, etc.), and may also be used for broadcast scheduling, such as paging messages.

Act 8-6 comprises determining if a paging message is detected. The paging message detection is enabled for a paging time window (PTW). If a paging message is detected, as act 8-8 the wireless terminal 26 starts network communication. Network communication as commenced at act 8-8 involves a yet further power increase, greater than the power level of act 8-5 required for paging message monitoring. If a paging message is not detected at act 8-6, as act 8-7 a check is make whether the paging time window (PTW) has expired. If the paging time window (PTW) has not expired, the monitoring of the paging channel continues as indicated by an execution loop back to act 8-5. Otherwise, if the paging time window (PTW) has expired, execution loops back to act 8-3 to return to the state of monitoring for wake up signaling.

Thus, as understood from FIG. 8, when the current wake up signaling state is the enable wake up signaling state, the receiver circuitry of the user equipment is configured to monitor for receipt of a wake up signal (see act 8-3). As explained above, the wake up signal, also known as wake up signaling, may be the indication 96 borne by message 98. Then, in response to receipt of the wake up signal, the receiver circuitry is configured to monitor for receipt of a paging message (see act 8-5). On the other hand, when the current wake up signaling state is the disable wake up signaling state the receiver circuitry does not monitor for the wake up signal, and the user equipment operates with lower power than when configured to monitor for receipt of the wake up signal.

FIG. 3, FIG. 5A and FIG. 5B, FIG. 6, FIG. 7A and FIG. 7B thus describe an example wherein an indication of the commanded wake up signaling state for the connected mode user equipment, e.g., indication 96, has been generated by an application server and routed though the core network and the radio access network in a message 98 to the connected mode user equipment. More particularly, FIG. 3, FIG. 5A and FIG. 5B, FIG. 6, FIG. 7A and FIG. 7B describe an example wherein the indication 96 of the commanded wake up signaling state for the user equipment has been routed from CIoT application server 60 though a Service Capability Exposure Function, SCEF 70, and a Mobility Management Entity, MME, 80, of the core network, to the radio access network 22 and ultimately to wireless terminal 26.

FIG. 9A-FIG. 9D show example methods of transmitting the wake up signaling state, e.g., the indication 96 of a commanded wake up signaling state, from the CIoT application server 60 to the connected mode wireless terminal 26. FIG. 9A shows a method of Detach triggered by MME; FIG. 9B shows a downlink (DL) Information Transfer method; FIG. 9C shows a method of transmitting the indication 96 of a commanded wake up signaling state using an RRCConnectionRelease message; and FIG. 9D shows a method of transmitting the indication 96 of a commanded wake up signaling state using a RRC TAU/RAU Response message. As mentioned above, the acts of FIG. 4 precede the acts of the methods of FIG. 9A-FIG. 9D.

FIG. 9A shows a method of Detach triggered by MME, e.g., an example situation in which the message 98A, which bears the indication 96 of the commanded wake up signaling state, is a non-access stratum detach request message. In essence, in the method of FIG. 9A, if a Detach is initiated by mobility management entity (MME) 80, a NAS Detach Request message is sent from the mobility management entity (MME) 80 to wireless terminal 26 while in connected mode. The wake up signaling state before the Detach Request is sent to the wireless terminal 26. The basic process for configuring and transmitting wake up signaling state to the wireless terminal 26 for FIG. 9 is as follows:

9A-1: wireless terminal 26 starts preparation setup process for MO data transport (See act 4-1 and act 4-2 of FIG. 4).
9A-2: Once setup is complete, wireless terminal 26 is ready to transmit UL data (see act 4-3 of FIG. 4).
9A-3: UL data is transmitted to the access node 24 (see act 4-3 of FIG. 4).
9A-4: Non-IP data eventually reaches CIoT application server 60 via Service Capability Exposure Function (SCEF) 90 and mobility management entity (MME) 80 (see act 4-4 through 4-6 of FIG. 4).
9A-5: CIoT application server 60 analyzes data and determines that a wake up signaling state change is necessary (see act 4-7 of FIG. 4).
9A-6: CIoT application server 60 sends a new wake up signaling state, e.g., indication 96 of a commanded wake up signaling state, to mobility management entity (MME) 80 using a new special service in Service Capability Exposure Function (SCEF) 90 (see act 9A-6 of FIG. 9A).
9A-7: mobility management entity (MME) 80 packages the wake up signaling state, e.g., indication 96 of a commanded wake up signaling state, as part of a UE Context Release message (see act 9A-7 in FIG. 9A).
9A-8: A NAS Detach Request message that encapsulates WUS state is transmitted to wireless terminal 26 from access node 24 (see act 9A-8 in FIG. 9). Concerning act 9A-8, a new Information Element (IE) within NAS Detach Request comprises the indication 96 of a commanded wake up signaling state, e.g., a new wake up signaling state flag. The indication 96 of a commanded wake up signaling state, which may be a flag, indicates WUS feature is turned ON or OFF. Once the RRC connection is released (see act 9A-9 of FIG. 9A), the wireless terminal 26 turns on/off its wake up signaling detector.

FIG. 9B shows a downlink (DL) Information Transfer method, e.g., a method wherein the message 98B which is received over the radio interface 28 is a downlink information transfer message which at least partially encapsulates a non-access stratum message, and wherein the non-access stratum message in turn comprises the indication 96 from the core network of the commanded wake up signaling state for the user equipment. Thus, in the method of FIG. 9B DL Information Transfer is used to encapsulate a NAS message with wake up signaling state, e.g., with indication 96 of a commanded wake up signaling state. Once the mobility management entity (MME) 80 is ready to send the wake up signaling state to the wireless terminal 26, a NAS message with wake up signaling state is packed in dedicatedNASInfo by mobility management entity (MME) 80 and transported by access node 24 to wireless terminal 26 using DL Information Transfer procedure. A basic process for using DL Information Transfer of FIG. 9B is as follows:

9B-1: wireless terminal 26 starts preparation setup process for MO data transport (See act 4-1 and act 4-2 of FIG. 4).
9B-2: Once setup is complete, wireless terminal 26 is ready to transmit UL data (see act 4-3 of FIG. 4).
9B-3: UL data is transmitted to the access node 24 (see act 4-3 of FIG. 4).
9B-4: Non-IP data eventually reaches CIoT application server 60 via Service Capability Exposure Function (SCEF) 90 and mobility management entity (MME) 80 (see act 4-4 through 4-6 of FIG. 4).
9B-5: CIoT application server 60 analyzes data and determines that a wake up signaling state change is necessary (see act 4-7 of FIG. 4).
9B-6: The wake up signaling state, e.g., indication 96 of a commanded wake up signaling state, is transferred to the mobility management entity (MME) 80 using special services in SCEF (see act 9B-6 in FIG. 9B).
9B-7: mobility management entity (MME) 80 packages the wake up signaling state in a NAS message (see act 9B-7 of FIG. 9B).
9B-8: A downlink (DL) Information Transfer message 98b carrying the NAS message (dedicatedInfoNAS) is sent from mobility management entity (MME) 80 to wireless terminal 26 via access node 24 (see act 9B-8 of FIG. 9B). The new WUS state flag IE is encapsulated in dedicatedInfoNAS. Because the UE may not require a new connection, a new EPS Mobility Management message is used for transport.
9B-9: Once the connection is released (see act 9B-9 of FIG. 9B), the wireless terminal 26 turns on/off WUS detector.

In the event that NAS Detach Request message is not sent by the network (see FIG. 9A), wake up signaling state may be transmitted to the UE using RRCConnectionRelease message. Accordingly, FIG. 9C shows a method of transmitting the indication 96 of a commanded wake up signaling state using an RRCConnectionRelease message. In other words, FIG. 9C shows a method comprising usage of an RRCConnectionRelease message, e.g., an example situation in which the message 98C which bears the indication 96 of the commanded wake up signaling state and which is received over the radio interface 28 is a radio resource control connection release message. The radio resource control connection release message of FIG. 9C at least partially includes a UE context release message, and the UE context release message in turn comprises the indication 96 from the core network of the commanded wake up signaling state for the user equipment. An RRCConnectionRelease message typically includes a Release Cause information element, but in the FIG. 9C example embodiment and mode also includes the wake up signaling state, e.g., indication 96 of a commanded wake up signaling state. In the method of FIG. 9C, mobility management entity (MME) 80 receives the wake up signaling state but has not started the RRC connection release process and mobility management entity (MME) 80 does not request a NAS Detach message.

An example basic process for using a RRCConnectionRelease message of FIG. 9C is as follows:

9C-1: UE and MME confirmed that WUS is supported based on UE Capability and System Information messages. Furthermore MME and UE support RRCConnectionRelease message with WUS state.
9C-2: wireless terminal 26 starts preparation setup process for MO data transport (See act 4-1 and act 4-2 of FIG. 4).
9C-3: UL data is transmitted to the access node 24 (see act 4-3 of FIG. 4).
9C-4: Non-IP data eventually reaches CIoT application server 60 via Service Capability Exposure Function (SCEF) 90 and mobility management entity (MME) 80 (see act 4-4 through 4-6 of FIG. 4).
9C-5: CIoT application server 60 analyzes data and determines that a wake up signaling state change is necessary (see act 4-7 of FIG. 4).
9C-6: The wake up signaling state, e.g., indication 96 of a commanded wake up signaling state, is transferred to the mobility management entity (MME) 80 using special services in SCEF (see act 9C-6 in FIG. 9C).
9C-7: The wireless terminal 26 initiates a release since the mobility management entity (MME) 80 does not send a NAS Detach command
9C-8: The mobility management entity (MME) 80 packages the wake up signaling state as part of a UE Context Release message (see act 9C-8 of FIG. 9C).
9C-9: The access node 24 receives the UE Context Release command from mobility management entity (MME) 80 (see act 9C-8 of FIG. 9C).
9C-10: The access node 24 transmits a RRCConnectionRelease message with the wake up signaling state, e.g., indication 96 of a commanded wake up signaling state to the wireless terminal 26 (see act 9C-10 of FIG. 9C).
9C-11: Once the connection is released, wireless terminal 26 turns on/off its wake up signaling detector.

As indicated above, for the FIG. 9C example embodiment and mode both wireless terminal 26 and core network 21 need to support wake up signaling. Confirmation of support of wake up signaling is based on UE Capability and System Information. If wake up signaling is supported, the RRConnectionRelease contains wake up signaling state IE in addition to the Release Cause.

FIG. 9D shows a method of transmitting the indication 96 of a commanded wake up signaling state using a RRC TAU/RAU Response message. In other words, FIG. 9D shows a method comprising using a RRC TAU/RAU Response message, e.g., an example situation in which the message 98D, which bears the indication 96 of the commanded wake up signaling state and which is received over the radio interface 28 by the connected mode wireless terminal 26, is a tracking/routing area update accept response message. Thus, as shown in FIG. 9D, the wake up signaling state may be transmitted to wireless terminal 26 by responding to TAU requests. Several actions enable the generation of a TAU Request message by the wireless terminal 26. One example is the expiration of Power Savings Mode (PSM) timer. Upon receipt of a TAU Request message, the network responds with TAU Reject/Accept message. In the example embodiment and mode of FIG. 9D, the TAU Accept message may comprise the wake up signaling state.

An example basic process for using a RRC TAU/RAU Response message of FIG. 9D is as follows:

9D-1: UE and MME confirmed that wake up signaling is supported based on UE Capability and System Information messages. Furthermore MME and UE support RRCConnectionRelease message with wake up signaling state.
9D-2: wireless terminal 26 starts preparation setup process for MO data transport (See act 4-1 and act 4-2 of FIG. 4).
9D-3: UL data is transmitted to the access node 24 (see act 4-3 of FIG. 4).
9D-4: Non-IP data eventually reaches CIoT application server 60 via Service Capability Exposure Function (SCEF) 90 and mobility management entity (MME) 80 (see act 4-4 through 4-6 of FIG. 4).
9D-5: CIoT application server 60 analyzes data and determines that a wake up signaling state change is necessary (see act 4-7 of FIG. 4).
9D-6: The wake up signaling state, e.g., indication 96 of a commanded wake up signaling state, is transferred to the mobility management entity (MME) 80 using special services in SCEF (see act 9D-6 in FIG. 9D).
9D-7: mobility management entity (MME) 80 stores the wake up signaling state until a TAU Request is received (see act 9D-7 in FIG. 9D).
9D-8: The RRC Connection is terminated (see act 9D-8 in FIG. 9D).
9D-9: TAU Request is received from wireless terminal 26 (see act 9D-9 in FIG. 9D).
9D-10: mobility management entity (MME) 80 packages wake up signaling state as part of TAU Accept message (see act 9D-10 in FIG. 9D).
9D-11: Access node 24 receives TAU Accept with wake up signaling state from MME (see act 9D-10 in FIG. 9D).
9D-12: Access node 24 transmits the TAU Accept message with wake up signaling state to wireless terminal 26 (see act 9D-11 in FIG. 9D).
9D-13: Once the RRC connection is released, wireless terminal 26 turns on/off its wake up signaling detector.

In example embodiments and modes described above, the wake up signaling state controller 30 serves to enable or disable the wake up signaling while wireless terminal 26 is in a connected mode. The ability to control the state of wake up signaling allows wireless terminal 26 to be reachable and yet, maximizing battery life. The wireless terminal 26 must be in a reachable state before any pages can be received from the core network 21. If the wake up signaling detector is turned on, paging can be sent any time but the second will still consume more power compared to sleep state (wake up signaling disabled). Therefore, the ability to turn off the wake up signaling detector, in the manner described herein, is useful.

In the UE connected mode example embodiments and modes described above, in a typical case, wireless terminal 26 transmits uplink data (UL) data via e-NodeB (access node 24. Based on the data, the Application Server 60 may decide that the wake up signaling needs to be disabled. In this case, the Application Server 60 using Service Capability Exposure Function (SCEF) 90 connected to the mobility management entity (MME) 80, may transmit a wake up signaling disable message while the wireless terminal 26 is in connected mode. Conversely, based on data analysis, the Application Server may decide that wake up signaling should be enabled if the current state is off. In that case, the wireless terminal 26 will be reachable allowing paging messages be sent for monitoring by wireless terminal 26. A command to disable wake up signaling during the time period results in minimal power consumption and after the expiration of the wake up signaling timer, the wireless terminal 26 enables wake up signaling monitoring and thus achieves a reachable state.

The example embodiments and modes described above, in which the wake up signaling state controller 30 serves to enable or disable the wake up signaling while wireless terminal 26 is in a connected mode, the following messages may be used to transmit the indication 96 of a commanded wake up signaling state: MME messages with wake up signaling configuration encapsulated in specific messages; and RRC messages embedded with wake up signaling configuration. Non-exhaustive example messages encompassed herein are illustrated in FIG. 9A-FIG. 9D.

Non-limiting example advantages and features of the connected mode example embodiments and modes described above include the following:
1) Wake Up Signal (WUS) configuration originating from an Application Server and reaching a Mobility Management Entity (MME) via SCEF.
2) A new WUS exposure function for SCEF
3) WUS configuration state (enable/disable)
4) MME transmits WUS configuration to the UE using NAS and RRC messages.
5) NAS messages used for transmission of WUS configuration include DL Information transport and NAS detach
6) RRC messages that contain WUS configuration includes RRCConnectionRelease and Tracking Area Update (TAU) accept message
7) The transmission of WUS configuration occurs while the UE is in connected mode
8) System Information (SI) acquisition is not required to determine WUS configuration

In other example embodiments and modes described hereafter, the wireless terminal 26 need not be in the connected mode to receive wake up signaling, e.g., need not be in the connected mode to receive an indication of a commanded wake up signaling state for the user equipment. Moreover, in at least some of the example embodiments and modes described hereafter, the uplink (UL) transmissions from the wireless terminal 26 are not necessarily required in order to generate wake up signaling. For example, using certain lower layer signaling, e.g., e.g., the physical layer (Layer 1) and the MAC layer (Layer 2), some of the example embodiments and modes described hereinafter do not necessarily require UL data transmissions or other ways to set up connection with the network. As such, certain example methods described hereinafter enable/disable wake up signaling to be applicable even to wireless terminals not in connected mode. Some of the example embodiments and modes described hereinafter utilize the fact that the indication of a commanded wake up signaling state may be information that may be conveyed with a flag, such as one bit having either an OFF or ON value.

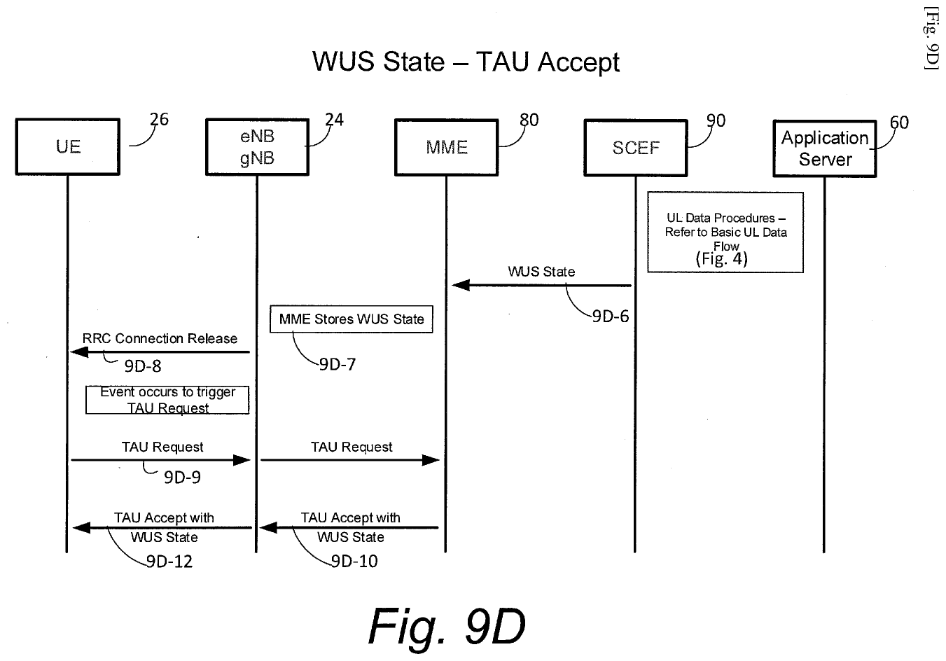

In some of the following example embodiments and modes, the wireless terminal need not receive “bilateral” wake up signaling. That is, the wireless terminal need not receive both enabled wake up signaling and disabled wake up signaling state, as one or the other of the enabled wake up signaling and disabled wake up signaling may be sufficient for operation of the wireless terminal. For example, FIG. 10 shows wireless terminal 26(10) that comprises a “unilateral” wake up signaling state controller 30(10). The wake up signaling state controller 30(10) is “unilateral” in the sense that wireless terminal 26(10) need receive only one of enabled wake up signaling and disabled wake up signaling, but not both. Moreover, in at least some of the ensuing example embodiment and modes, the generating of the enabled wake up signaling and/or disabled wake up signaling need not necessarily depend on uplink data from a connected mode wireless terminal, since in at least some of the ensuing example embodiment and modes the wireless terminal need not be in the RRC connected mode. For example, in the ensuing example embodiments and modes the wireless terminal that receives the enabled wake up signaling and/or disabled wake up signaling may be operating in another RRC mode, such as idle mode.

In at least some of the ensuing example embodiments and modes, the structure of the devices and nodes shown in FIG. 10 may be essentially the same as those of FIG. 3, possibly with the exception of the unilateral capability of the wake up signaling state controller 30(10), and with some functionalities which are optional being shown in broken lines. For other ensuing example embodiments and modes described hereinafter, while diagrams depicting the systems of the ensuing example embodiments and modes may continue to show radio access network and core network structure similar to FIG. 3 for sake of illustration, such radio access network and/or core network structure need not be identical to FIG. 3. It should therefore be understood, in the example embodiments and modes hereinafter described, such enabled wake up signaling and/or disabled wake up signaling may be generated or included in messages by any appropriate node or server, such as a server at a core network node, the CIoT application server 60 being just one non-limiting example. In generating the wake up signaling, the server or network node need not, but may, operate on the basis of connected mode uplink data, and could instead base a decision whether to send wake up signaling on factors such as optimization of CIoT device battery, or need for additional data to be transmitted by the CIoT device, whether based on data from the CIoT device or not. Thus, in general, in at least some example embodiments and modes it should be appreciated that at least some node(s) or server(s) of the network generate the enabled wake up signaling and/or disabled wake up signaling, and that optionally other node(s) may include such enabled wake up signaling and/or disabled wake up signaling in an appropriate message that is ultimately transmitted to the wireless terminal.

In the example embodiment and mode of FIG. 10, the terminal receiver circuitry 36 of wireless terminal 26(10) obtains, over the radio interface 28, wake up signaling state information for the user equipment. The wake up signaling state information may also be referred to herein as wake up signaling state information 196 indicating a commanded wake up signaling state, or more simply, “wake up signaling state information 196”. FIG. 10 shows by an arrow a generic message 198 received by wireless terminal 26(10) which includes the wake up signaling state information 196. In the FIG. 10 example embodiment and mode, the wake up signaling state information 196 for the wireless terminal 26(10) is either (1) that wake up signal detection is to be enabled at the wireless terminal 26(10), or (2) that wake up signal detection is to be disabled at the wireless terminal 26(10). In being one but not both of (1) wake up signal detection enablement and (2) that wake up signal detection disablement, the wake up signaling state information 196 is unilateral.

The processor 40 of wireless terminal 26(10), and unilateral wake up signaling state controller 30(10) in particular, upon reception of the wake up signaling state information, enters the commanded wake up signaling state indicated by the wake up signaling state information. The wireless terminal 26(10) remains in the commanded wake up signaling state for a configured duration. Upon reaching the configured duration, the unilateral wake up signaling state controller 30(10) transitions to a non-commanded wake up signaling state.

The wake up signaling state information 196 may be generated by a node of the core network 21, such as CIoT application server 60. The node processor 50 of access node 24 may serve to include the unilateral wake up signaling state information 196 in a message such as illustrated as WUS state information-bearing message 198 in FIG. 10. As explained above, the wake up signaling state information 196 is an indication of a commanded wake up signaling state for a user equipment in a message, the commanded wake up signaling state being just one of an enable wake up signaling state or a disable wake up signaling state. The node transmitter circuitry 54 of access node 24 transmits a message which includes the commanded wake up signaling state over the radio interface to wireless terminal 26(10).

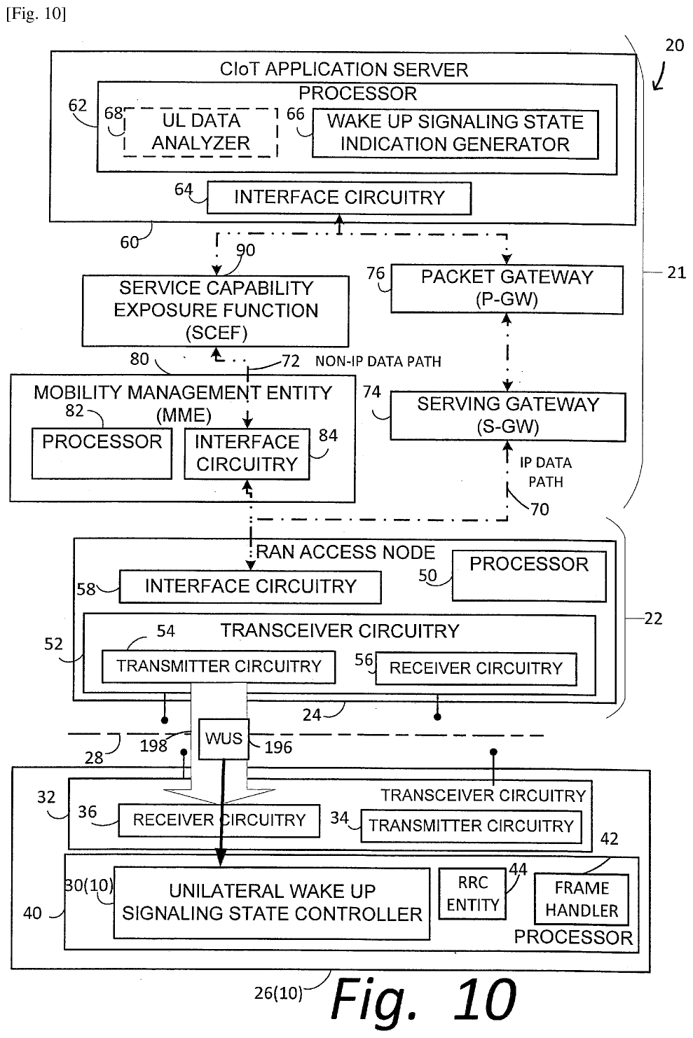

FIG. 11 shows representative, basic, example acts or steps performed by the wireless terminal 26(10) of FIG. 10. Act 11-1 comprises obtaining unilateral wake up signaling state information 196. As explained above, the unilateral wake up signaling state information 196 is obtained over the radio interface and indicates a commanded wake up signaling state for the user equipment. The commanded wake up signaling state is either (1) that wake up signal detection is to be enabled at the user equipment, or (2) that wake up signal detection is to be disabled at the user equipment. Act 11-2 comprises, upon reception of the wake up signaling state information, entering the commanded wake up signaling state indicated by the wake up signaling state information. Act 11-3 comprises remaining in the commanded wake up signaling state for a configured duration. Act 11-4 comprises, upon reaching the configured duration, transitioning to a non-commanded wake up signaling state.

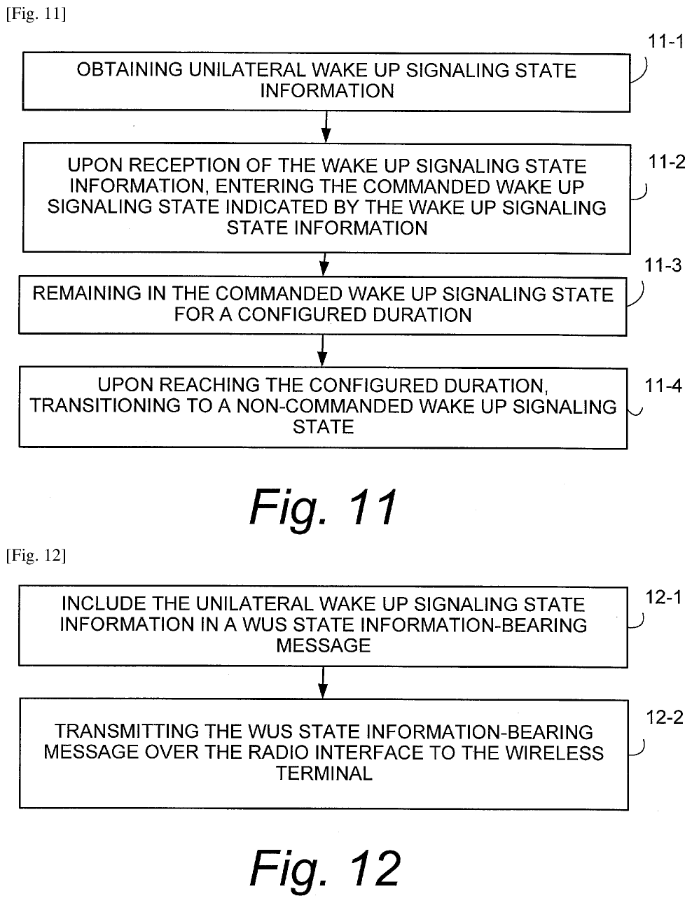

FIG. 12 shows example, representative, basic acts or steps that may be performed by access node 24 for the example embodiment and mode of FIG. 10. Act 21-1 comprises using processor circuitry to include the unilateral wake up signaling state information 196 in WUS state information-bearing message 198. Act 12-2 comprises transmitting the WUS state information-bearing message 198 over the radio interface to the wireless terminal 26(10).

For example, considering the methods of FIG. 11 and FIG. 12, assume that the unilateral wake up signaling state information 196 indicates that wake up signal detection is to be enabled at wireless terminal 26(10). In such case, as act 11-2 the wake up signal detection is enabled, and remains enabled for a configured duration (act 11-3). Upon reaching the configured duration, as act 11-4 the wireless terminal 26(10) transitions to a non-commanded wake up signaling state, i.e., to a disabled wake up signaling state. This scenario is just one example, as the converse situation could instead be implemented wherein the unilateral wake up signaling state information 196 indicates that wake up signal detection is to be disabled, and the non-commanded wake up signaling state to which the wireless terminal 26(10) transitions at act 11-4 is the enabled wake up signaling state.

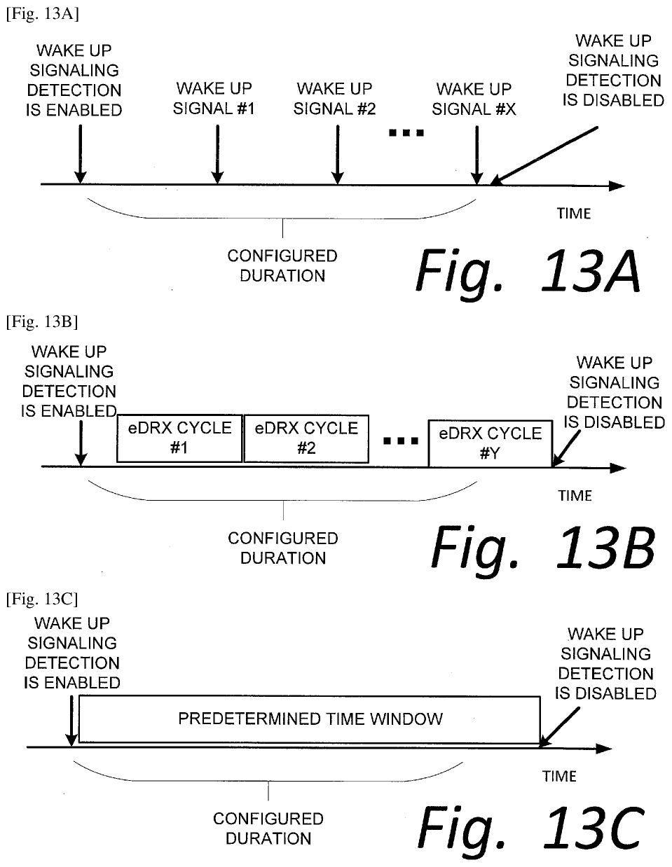

FIG. 13A-FIG. 13D show differing examples of how the configured duration (act 11-3) may be represented or expressed in a situation in which the unilateral wake up signaling state information 196 indicates that wake up signal detection is to be enabled at wireless terminal 26(10). FIG. 13A shows, for example, that the configured duration may corresponds to a time period until which the user equipment detects a predetermined number of wake up signals. Thus, in the scenario of FIG. 13A, after receiving the WUS state information-bearing message 198 which turns on the wake up signaling detection, the unilateral wake up signaling state controller 30(10) begins and keeps monitoring wake up signaling signal until the wake up signaling detector successfully detects the first X number of wake up signaling signals. X may be an integer equal or greater than 0, for example, X=1.

FIG. 13B shows another example of configured duration, wherein the configured duration corresponds a predetermined number of LTE extended discontinuous reception (eDRX) cycles. Thus, in the scenario of FIG. 13b, after receiving the WUS state information-bearing message 198 which turns on the wake up signaling detection, the unilateral wake up signaling state controller 30(10) begins and keeps monitoring wake up signaling signal until completion of the first Y number of eDRX cycles right after detection is enabled, where, Y is integer equal or greater than 0, for example, Y=1.

FIG. 13C shows another example of configured duration, wherein the configured duration corresponds a predetermined time window.

FIG. 13C shows another example of configured duration, wherein the configured duration corresponds a countdown, or count up, period of a timer. In the case that the timer is a countdown timer, the configured duration may terminate when the counter, having been initialized at a value corresponding to the configured duration, expires at zero. Conversely, in the case that the timer is a count up timer which has been initialized at zero, the detection period may terminate when the counter has reached it predetermined or programmed maximum, which corresponds to the configured duration.

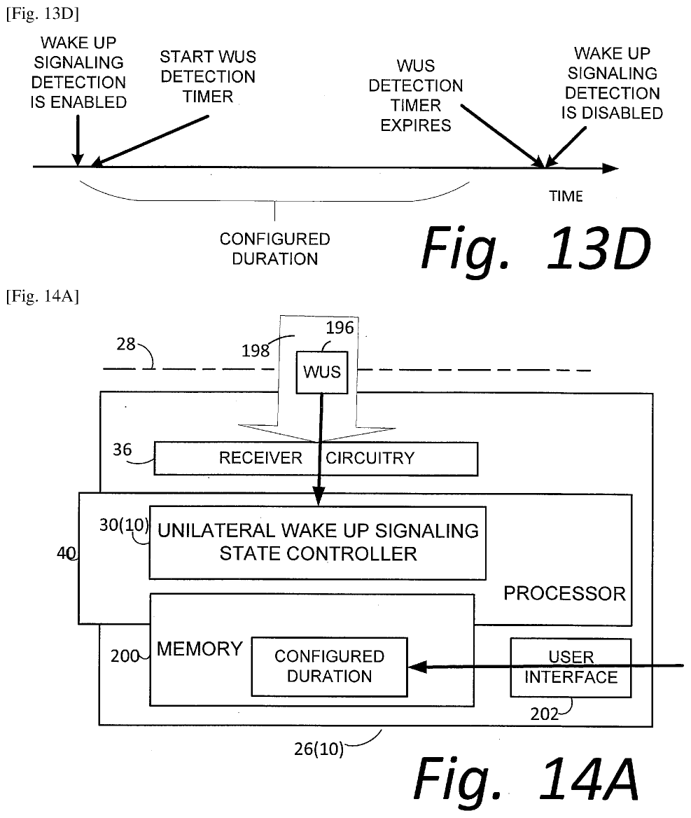

Thus, the examples of FIG. 13A-FIG. 13D show differ ways of expressing or representing the configured duration, e.g., a measure of how long the wake up signaling detection is to remain active upon receipt of a unilateral wake up signaling state information 196. In differing example embodiments and modes, the configuration duration may either be preconfigured in memory of wireless terminal 26(10), or configured in memory of the wireless terminal 26(10) by a signal received over the radio interface 28. FIG. 14A shows an example implementation in which the configured duration is preconfigured in terminal memory 200 of wireless terminal 26(10). The preconfigured configured duration may be loaded into terminal memory 200 via interface 202, which may be a user interface or an installation interface. The loading of the configured duration via may occur, for example, at factory or shop programming of the wireless terminal 26(10).

FIG. 14B shows an example implementation in which the configured duration is pre-configured in terminal memory 200 of wireless terminal 26(10) by a configured duration download signal 204 received over the radio interface 28. FIG. 14B also shows various example forms of message or signaling that the configured duration download signal 204 may take. For example, the configured duration download signal 204 may be included in a medium access control (MAC) control element (CE), a system information block (SIB), or a dedicated radio resource control (RRC) message.

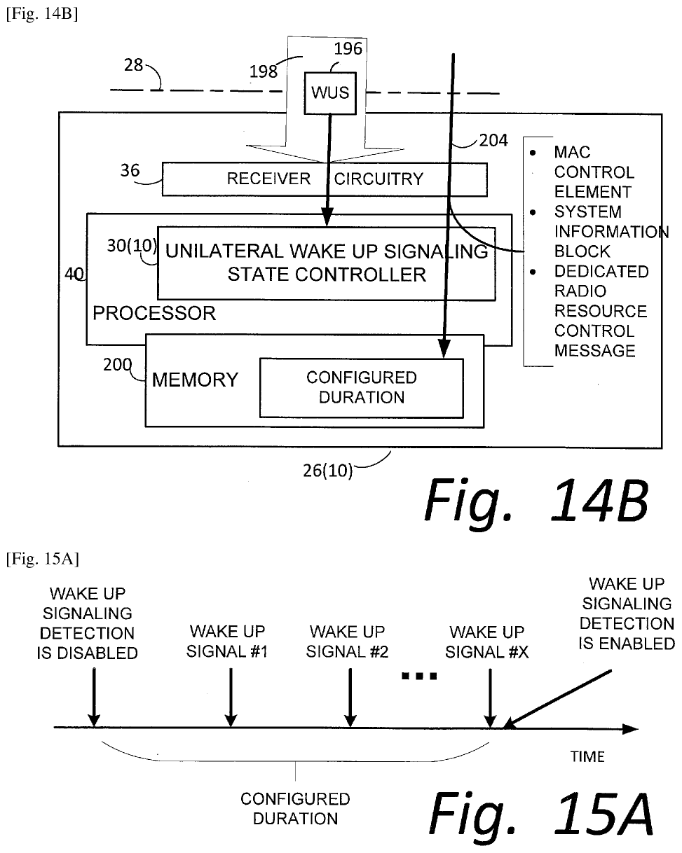

In an alternate implementation of the FIG. 13 example embodiment and mode, that the unilateral wake up signaling state information 196 may indicate that wake up signal detection is to be disabled at wireless terminal 26(10). In other words the wake up signaling disable information is delivered to wireless terminal 26(10); while the wake up signaling enable information does not need to be delivered to wireless terminal 26(10). In this alternative implementation, the default behavior or state of operation of the wireless terminal 26(10) is to always perform wake up signaling detection until such detection is deactivated, e.g., by receipt from the network of a deactivation or disable wake up signaling state information 196. In such alternative the configured duration corresponds to the time for which the wake up signaling detection is deactivated. For such alternative wherein wake up signaling detection is the default mode, FIG. 15A-FIG. 15D show differ ways of expressing or representing the configured duration, e.g., a measure of how long the wake up signaling detection is to remain disabled upon receipt of a unilateral wake up signaling state information 196. The configured duration expressions or representations of FIG. 15A-FIG. 15D are similar to and understood with respect to FIG. 13A-FIG. 13D, a primary difference being that at the end of the configured duration the wake up signaling detection is resumed. It should be understood that the configured duration parameter utilized for the alternative implementation wherein the wake up signaling state information 196 provides unilateral disablement of the wake up signaling can be preconfigured at the wireless terminal 26(10) in the manner of FIG. 14A or downloaded to the wireless terminal 26(10) in the manner of FIG. 14B.

Whereas the example embodiment and mode of FIG. 10 concerned unilateral wake up signaling, in other example embodiments and modes described herein both wake up signaling detection enabling and disabling signaling may be delivered to the wireless terminal. These other example embodiments and modes in which both wake up signaling detection enabling and disabling signaling may be delivered to the wireless terminal may be referred to as “bilateral” wake up signaling embodiments and modes. In the bilateral embodiments and modes, the wireless terminal may detects the wake up signaling signal after it is enabled to do so by an enablement signal, and stops detecting wake up signaling signal after it is disabled to do so by a disablement signal. In some example embodiments and modes, an example technique for carrying the enable/disable information is to carry one bit information (having values 0 and 1, representing enable and disable, or disable and disable respectively).

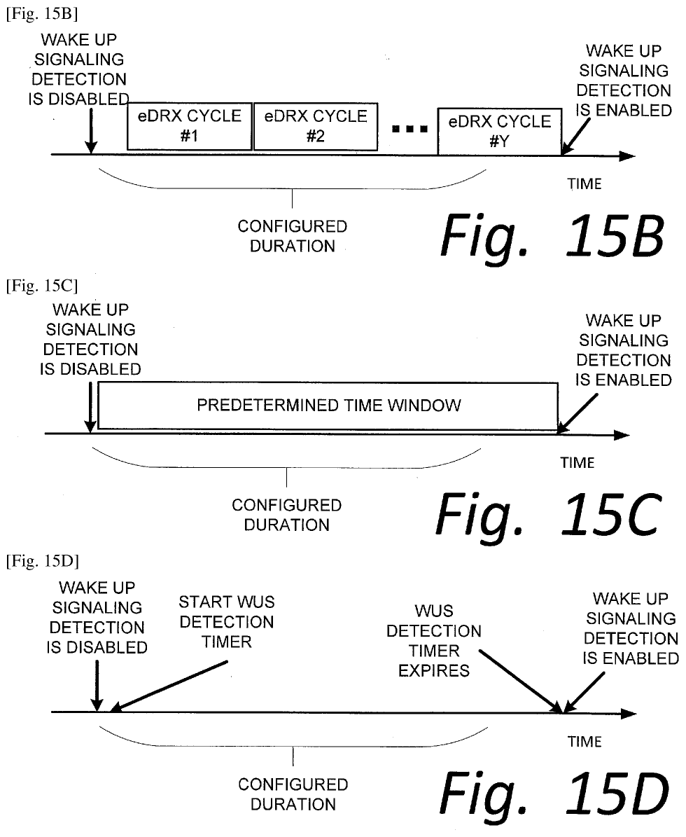

FIG. 16 shows an example bilateral embodiment and mode in which wireless terminal 26(16) determines from the medium access control (MAC) control elements (CE) both when wake up signaling detection is to be enabled at the wireless terminal and when wake up signaling detection is to be disabled at the wireless terminal. In other words, in the example of FIG. 16, medium access control (MAC) control elements (CE) indicate both when wake up signaling detection is to be enabled at the wireless terminal and when wake up signaling detection is to be disabled at the wireless terminal. In the FIG. 16 embodiment and mode terminal receiver circuitry 36 obtains medium access control (MAC) control elements (CE) over the radio interface. For example, FIG. 16 shows the WUS state information-bearing message 198(16) as comprising a MAC CE. Upon receipt by the wireless terminal, the medium access control (MAC) control element (CE) may be handled by MAC entity 210. Processor 40, particularly MAC CE-based wake up signaling state controller 30(16), receives the medium access control (MAC) control element (CE) from MAC entity 210 and determines from the medium access control (MAC) control element (CE) both when wake up signaling detection is to be enabled at the wireless terminal and when wake up signaling detection is to be disabled at the wireless terminal.

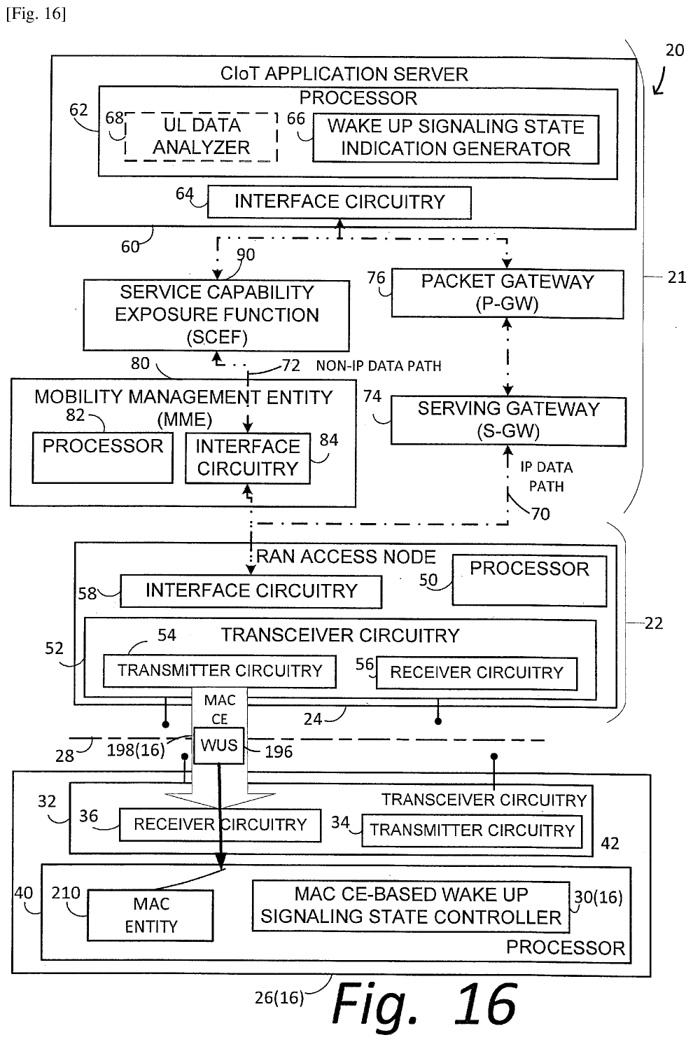

For example, upon first reception of a certain numbered MAC CE, the wake up signaling state controller 30(18) may determine that the wake up signaling detection is to be enabled. Subsequently, upon a further reception of the same numbered MAC CE having a different value, the wake up signaling state controller 30(16) may determine that the wake up signaling detection is to be disabled FIG. 17 shows example, representative, basic acts or steps performed by the wireless terminal 26(16) of FIG. 16 in an example mode. Act 17-1 comprises obtaining medium access control (MAC) control elements (CE) over the radio interface. Act 17-2 comprises determining, from the medium access control (MAC) control elements (CE), both when wake up signaling detection is to be enabled at the wireless terminal and when wake up signaling detection is to be disabled at the wireless terminal. Act 17-3 comprises operating the wake up signaling detection for the wireless terminal in accordance with a received medium access control (MAC) control elements (CE).

In the example embodiment and mode of FIG. 16 and FIG. 17, the MAC CE-based wake up signaling state controller 30(16) determines that wake up signaling detection is to be enabled at the wireless terminal when a particular medium access control (MAC) control element (CE) has a first value (e.g., a certain bit of the MAC CE has a 1 value) and determines that wake up signaling detection is to be disabled at the wireless terminal when the same particular medium access control (MAC) control element (CE) subsequently has a second value (e.g., the same bit position of the MAC CE has a 0 value). The assigment of 0 or 1 for the MAC CE bit for enablement and disablement may, of course, be reversed if desired.

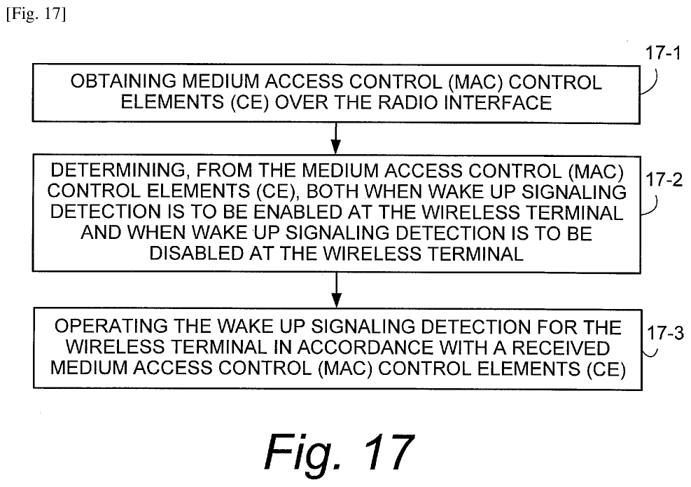

FIG. 18 shows an example bilateral embodiment and mode in which wireless terminal 26(18) determines from broadcasted system information both when wake up signaling detection is to be enabled at the wireless terminal and when wake up signaling detection is to be disabled at the wireless terminal. In other words, in the example of FIG. 18, broadcasted system information, such as information in a system information block (SIB), indicate both when wake up signaling detection is to be enabled at the wireless terminal and when wake up signaling detection is to be disabled at the wireless terminal. In the FIG. 18 embodiment and mode terminal receiver circuitry 36 obtains broadcasted system information over the radio interface. For example, FIG. 18 shows the WUS state information-bearing message 198(18) as comprising a SIB. Upon receipt by the wireless terminal, the broadcasted system information may be handled by SIB handler 212. Processor 40, particularly SIB-based wake up signaling state controller 30(18), receives the broadcasted system information from SIB handler 212 and determines from the broadcasted system information both when wake up signaling detection is to be enabled at the wireless terminal and when wake up signaling detection is to be disabled at the wireless terminal. For example, upon first reception of the broadcasted system information, e.g., a first reception of a certain SIB, the wake up signaling state controller 30(18) may determine that the wake up signaling detection is to be enabled. Subsequently, upon a reception of further broadcasted system information having a different value, e.g., for the same number system information block (SIB), the wake up signaling state controller 30(18) may determine that the wake up signaling detection is to be disabled.

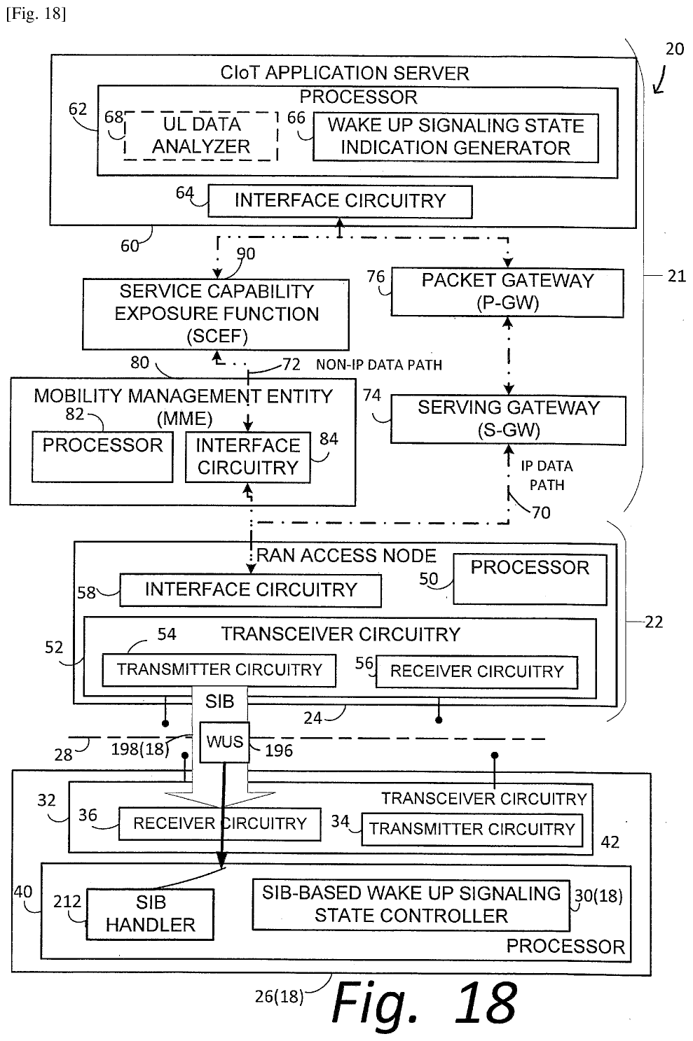

FIG. 19 shows example, representative, basic acts or steps performed by the wireless terminal 26(18) of FIG. 18 in an example mode. Act 19-1 comprises obtaining system information over the radio interface. Act 19-2 comprises determining, from the broadcasted system information, both when wake up signaling detection is to be enabled at the wireless terminal and when wake up signaling detection is to be disabled at the wireless terminal. Act 19-3 comprises operating the wake up signaling detection for the wireless terminal in accordance with the receivied broadcasted system information.

In the example implementation of the embodiment and mode of FIG. 18 and FIG. 19, the SIB-based wake up signaling state controller 30(18) determines that wake up signaling detection is to be enabled at the wireless terminal when a particular system information block (SIB) has a first value (e.g., a certain bit of SIB #X has a 1 value) and determines that wake up signaling detection is to be disabled at the wireless terminal when the same particular system information block (SIB) has a second value (e.g., the same bit position of the SIB #X has a 0 value). The assigment of 0 or 1 for the SIB bit for enablement and disablement may, of course, be reversed if desired.

In the example implementation of the embodiment and mode of FIG. 18 and FIG. 19, if the enable and/or disable information is carried by broadcasting signaling, e.g., some system information, the UE does not have to always acquire system information until it receives notification indicating there is system information change, e.g., through paging information indication, or system information value tag change (systemInfoValueTag information element carried by SIB1). Therefore, when the wireless terminal decodes paging information and knows there is system information change (the wireless terminal does not know the reason of system information change before decoding system information), the wireless terminal needs to re-acquire system information to check whether there is new configuration from network about enabling/disabling WUS detection. With this method, the wireless terminal's WUS detection activation/deactivation is actually triggered by the event of system information change, and if the network wants to configure the wireless terminal with WUS detection activation/deactivation, the network should send wireless terminal system information modification.

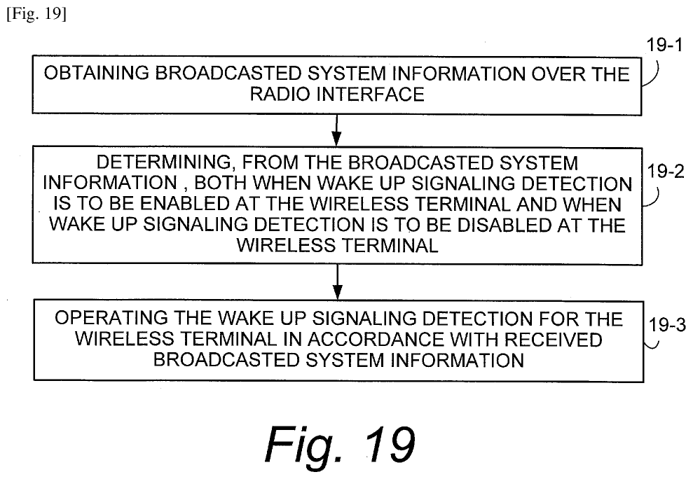

FIG. 20 shows an example bilateral embodiment and mode in which wireless terminal 26(18) determines from paging downlink control information, PDCI, both when wake up signaling detection is to be enabled at the wireless terminal and when wake up signaling detection is to be disabled at the wireless terminal. In other words, in the example of FIG. 20, paging downlink control information indicates both when wake up signaling detection is to be enabled at the wireless terminal and when wake up signaling detection is to be disabled at the wireless terminal. In the FIG. 20 embodiment and mode terminal receiver circuitry 36 obtains paging downlink control information over the radio interface. For example, FIG. 20 shows the WUS state information-bearing message 198(20) as comprising a PDCI. Upon receipt by the wireless terminal, the paging downlink control information may be handled by paging handler 214. Processor 40, particularly PDCI-based wake up signaling state controller 30(20), receives the paging downlink control information from paging handler 214 and determines from the paging downlink control information both when wake up signaling detection is to be enabled at the wireless terminal and when wake up signaling detection is to be disabled at the wireless terminal. For example, upon first reception of the paging downlink control information, the PDCI-based wake up signaling state controller 30(20) may determine that the wake up signaling detection is to be enabled. Subsequently, upon a further reception of paging downlink control information having a different value, PDCI-based wake up signaling state controller 30(20) may determine that the wake up signaling detection is to be disabled.

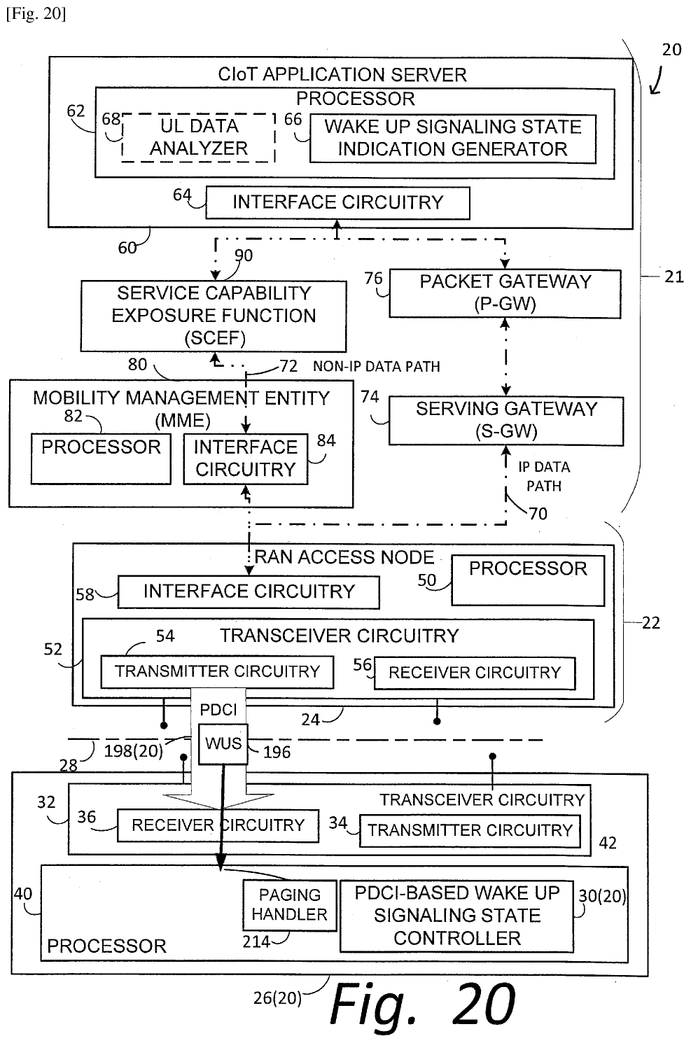

FIG. 21 shows example, representative, basic acts or steps performed by the wireless terminal 26(20) of FIG. 20 in an example mode. Act 20-1 comprises obtaining paging downlink control information over the radio interface. Act 20-2 comprises determining, from the paging downlink control information, both when wake up signaling detection is to be enabled at the wireless terminal and when wake up signaling detection is to be disabled at the wireless terminal. Act 20-3 comprises operating the wake up signaling detection for the wireless terminal in accordance with the received paging downlink control information.

In the example implementation of the embodiment and mode of FIG. 20 and FIG. 21, the PDCI-based wake up signaling state controller 30(20) determines that wake up signaling detection is to be enabled at the wireless terminal when a paging downlink control information has a first value (e.g., a 1 value) and determines that wake up signaling detection is to be disabled at the wireless terminal when a second reception of the same paging downlink control information has a second value (e.g., a 0 value). The assignment of 0 or 1 for the PDCI bit for enablement and disablement may, of course, be reversed if desired.

In an example implementation, in order to decode paging information, the wireless terminal 26(20) needs to monitor (N)PDCCH with paging RNTI, as the basic rule is paging information is carried by PCCH logical channel which is mapped to PCH transport channel, and the PCH transport channel is mapped to (N)PDSCH physical channel, and the eNB/gNB scrambles (N)PDCCH's CRC with P-RNTI for paging information transmission on PDSCH.

In this example implementation, two fixed value P-RNTTs may be defined, for example: (1) P-RNTI is the normal paging RNTI; and (2) P-RNTI_B corresponds to the paging RNTI indicating WUS detection enable or disable. If the network wants to modify the WUS detection, the network should scramble (N)PDCCH's CRC with PRNTI_B. If the wireless terminal is configured with one state of WUS detection, e.g., wake up signaling detection is enabled, then in the following paging information decoding, the wireless terminal should try both P-RNTI and P-RNTI_B to de-scramble (N)PDCCH's CRC; as for the order of trying P-RNTI and P-RNTI_B, it can be up to wireless terminal's implementation, or in a predefined order, e.g., trying P_RNTI_B firstly. If P-RNTI can decode paging information successfully, it means the UE should keep the current wake up signaling detection state; while if P-RNTI_B can decode paging information successfully, it means the wireless terminal should change the current wake up signaling detection state. With this design, there is no need to increase the load for paging channel.

For example, when the DCI format N2 for paging are defined as follows, the following information is transmitted by means of the DCI format N2:
If the format N2 CRC is scrambled by P-RNTI:
   Flag for paging/direct indication differentiation—1 bit, with value 0 for direct indication and value 1 for paging
If the format N2 CRC is scrambled by P-RNTI and Flag=0:
   Direct Indication information—8 bits provide direct indication of system information update and other fields
   Reserved information bits are added until the size is equal to that of format N2 with Flag=1
If the format N2 CRC is scrambled by P-RNTI and Flag=1, or if the format N2 CRC is scrambled by SC-RNTI:
   Resource assignment—3 bits
   Modulation and coding scheme—4 bits
   Repetition number—4 bits
   DCI subframe repetition number—3 bits

For WUS signal deactivation, a particular bit sequence may be mapped on one or more fields in the above. For example, for activation, all ones may be mapped on resource allocation field and/or modulation and coding scheme field and/or repetition number and/or DCI subframe repetition number. Alternatively, all ones may be mapped on direct indication information and/or Reserved information bits. One bit for deciding whether paging or WUS signal activation may be defined. Instead of all ones, all zeros or reserved values may be mapped.

For WUS signal deactivation, a particular bit sequence may be mapped on one or more fields in the above. For example, for activation, all ones may be mapped on resource allocation field and/or modulation and coding scheme field and/or repetition number and/or DCI subframe repetition number. Alternatively, all ones may be mapped on direct indication information and/or Reserved information bits. One or two bit for deciding whether paging, WUS signal activation, or deactivation may be defined. Instead of all ones, all zeros or reserved values may be mapped.

From the foregoing it can be seen that wireless terminal 26(20) may obtain the indication of a commanded wake up signaling state for the wireless terminal when at least a portion of the paging message is scrambled with a scrambling code associated with the wake up state signal for the wireless terminal. The scrambling code associated with the wake up state signal for the wireless terminal is wake up state paging radio network temporary identifier (P-RNTI′) that differs from a nominal paging radio network temporary identifier (P-RNTI′) for the wireless terminal. In an example implementation, the PDCI-based wake up signaling state controller 30(20) may interpret a paging message scrambled with the wake up state paging radio network temporary identifier (P-RNTI′) as indicating a transition/toggling between wake up signaling states. Moreover, in an example implementation the PDCI-based wake up signaling state controller 30(20) may ascertain the commanded wake up signaling state from a predetermined portion of the paging message scrambled with the wake up state paging radio network temporary identifier (P-RNTI′). Further, in an example implementation, the PDCI-based wake up signaling state controller 30(20) may ascertain, by a predetermined value comprising the predetermined portion of the paging message scrambled with the wake up state paging radio network temporary identifier (P-RNTI′), whether the commanded wake up signaling state is that that wake up signal detection is to be enabled at the wireless terminal or that wake up signal detection is to be disabled at the wireless terminal.

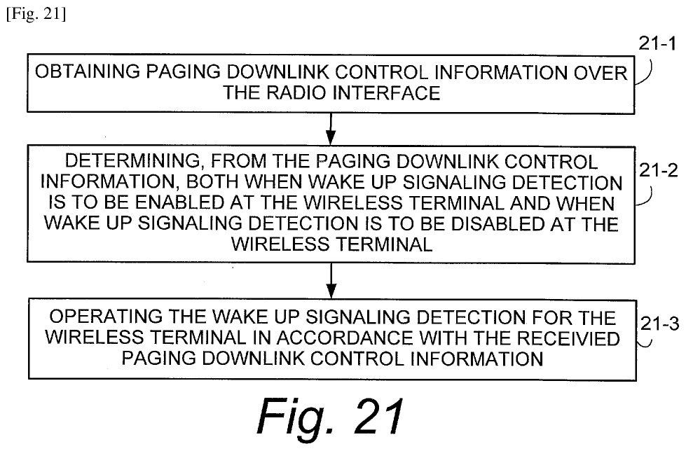

FIG. 22 shows an example bilateral embodiment and mode in which wireless terminal 26(22) determines from when wake up signaling detection is to be enabled at the wireless terminal and when wake up signaling detection is to be disabled at the wireless terminal from a one or more signaling sources, including a medium access control (MAC) control element (CE), broadcasted system information, and paging downlink control information. In the FIG. 22 example embodiment and mode, either (1) a wake up signaling detection enablement signal and a wake up signaling detection disablement signal may be received from the same signal source or signal type, e.g, one of MAC CE, SIB, or PDCI; or (2) a wake up signaling detection enablement signal may be received from a first signal source or signal type and a wake up signaling detection disablement signal may be received from a second signal source or signal type which is different from the first signal source or signal type. Thus, in the second alternative wherein different signal sources or signal types are used, the wake up signaling state controller 30(20) may be referred to as a combination-source wake up signaling state controller 30(20). Moreover, since either one or both of the wake up signaling detection enablement signal and the wake up signaling detection disablement signal may be received from more than one signal source or signal type, the wake up signaling state controller of FIG. 22 may also be referred to herein as dynamic source wake up signaling state controller 30(22).

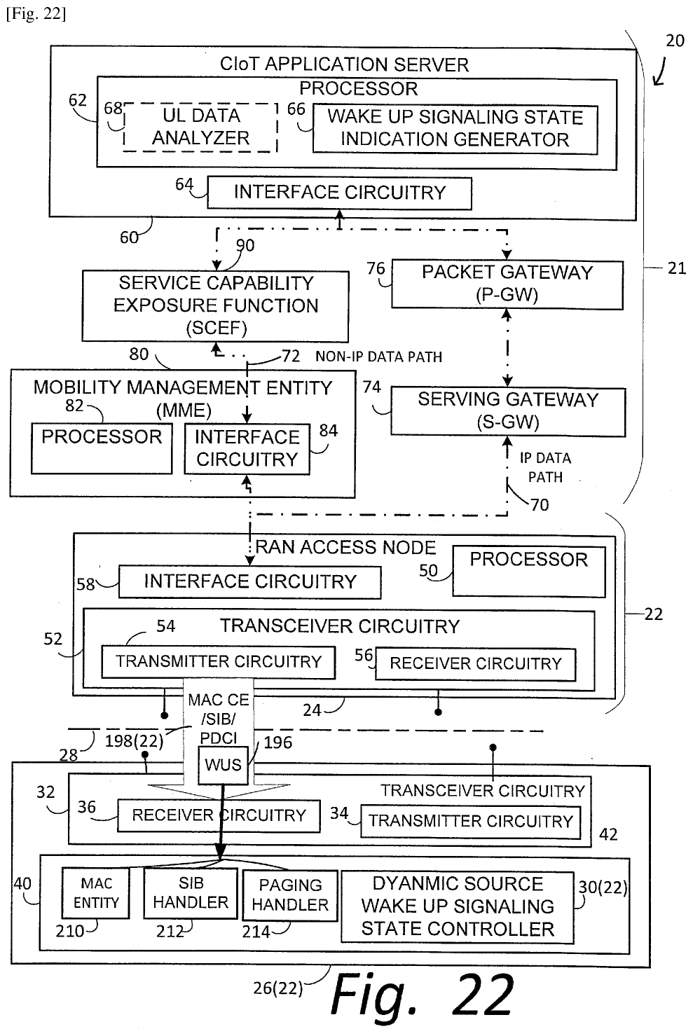

FIG. 23 shows example, representative, basic acts or steps performed by wireless terminal 26(22). The terminal receiver circuitry 36 of wireless terminal 26(22) may receive the following types of signals or messages over radio interface 28: medium access control (MAC) control elements (CE), broadcasted system information, and paging downlink control information. Act 23-1 thus comprises obtaining, over the radio interface, one or more of medium access control (MAC) control elements (CE); broadcasted system information; and paging downlink control information. The processor 40 of wireless terminal 26(22), and dynamic source wake up signaling state controller 30(22) in particular, may make two determinations. Act 23-2 comprises making a first determination when wake up signaling detection is to be enabled at the wireless terminal using at least one of the medium access control (MAC) control element (CE), the broadcasted system information, and the paging downlink control information. Act 23-3 comprises making a second determination when wake up signaling detection is to be disabled at the wireless terminal using at least one of the medium access control (MAC) control element (CE), the broadcasted system information, and the paging downlink control information. Act 23-4 comprises operating the wake up signaling detection of wake up signaling state controller 30(22) in accordance with the determinations of act 23-2 and 23-3.

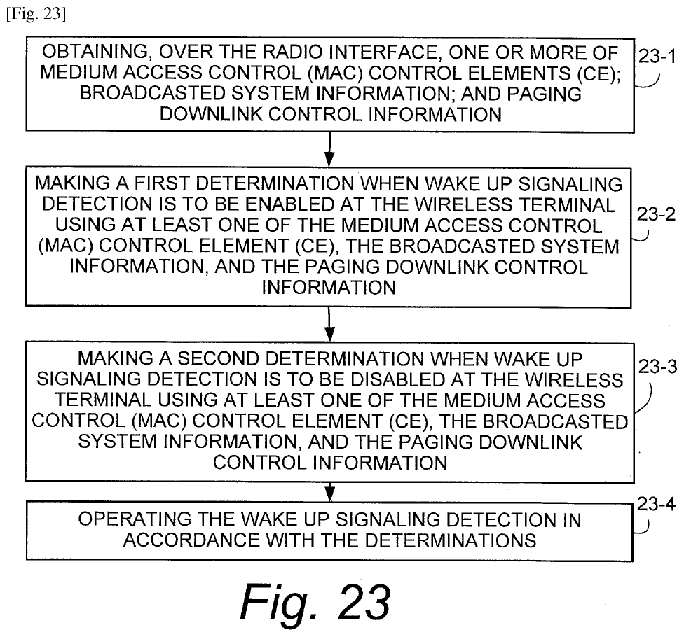

As indicated above, in some example implementations if FIG. 22 and FIG. 23 the dynamic source wake up signaling state controller 30(22) may make both the first determination and the second determination using a same one of the medium access control (MAC) control element (CE), the broadcasted system information, and the paging downlink control information. But such not need be the case in other example implementations. For example, FIG. 24 is a matrix showing possible combinations of signal sources and signal types for the wake up signaling detection enablement signal and the wake up signaling detection disablement signal.

In a variation of the example embodiment and mode of FIG. 22 and FIG. 23, plural ones of the medium access control (MAC) control element (CE), the broadcasted system information, and the paging downlink control information include information affecting the wake up signaling detection. That is, more than one of the medium access control (MAC) control element (CE), the broadcasted system information, and the paging downlink control information include information affecting wake up signaling detection. For example, both a MAC CE and a SIB may include information affecting wake up signaling detection. In such case of plural indications, the dynamic source wake up signaling state controller 30(22) is configured to select one of the signal sources or types to override the other, so that only one of the signal sources or types is operative to affect the wake up signaling detection. This is particularly important in a situation in which there is disagreement among the plural possible signal sources or types as to whether the wake up signaling detection should be enabled or disabled. Configuration information which prioritizes the signal sources or signal types for the dynamic source wake up signaling state controller 30(22) may be pre-stored at the wireless terminal 26(22) or downloaded from the network.

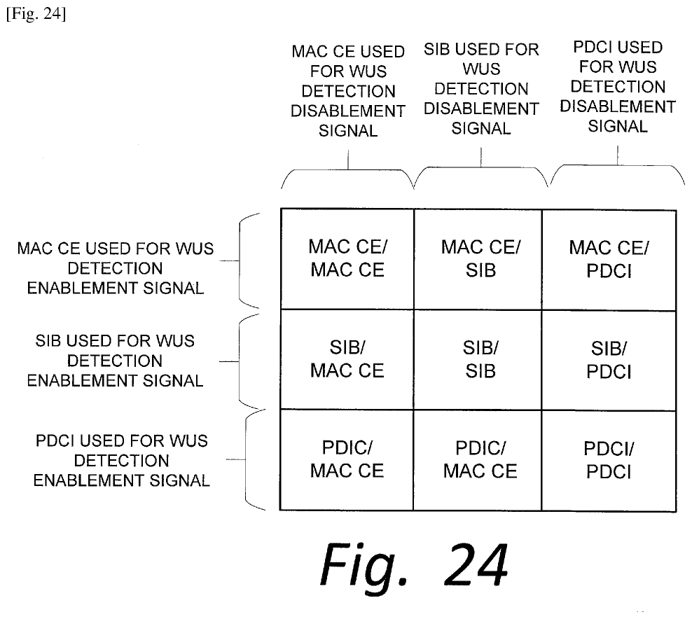

FIG. 25 shows an example bilateral embodiment and mode in which wireless terminal 26(25) determines from a message of the physical random access channel procedure both when wake up signaling detection is to be enabled at the wireless terminal and when wake up signaling detection is to be disabled at the wireless terminal. In other words, in the example of FIG. 25, the message of the physical random access channel procedure (PRACH) indicates both when wake up signaling detection is to be enabled at the wireless terminal and when wake up signaling detection is to be disabled at the wireless terminal. In the FIG. 25 embodiment and mode terminal receiver circuitry 36 obtains the message of the physical random access channel procedure over the radio interface. For example, FIG. 25 shows the WUS state information-bearing message 198(25) as comprising being a PRACH message. Upon receipt by the wireless terminal, the message of the physical random access channel procedure (PRACH) may be handled by PRACH controller 216. Processor 40, particularly PRACH-based wake up signaling state controller 30(25), receives the message of the physical random access channel procedure (PRACH) from PRACH controller 216 and determines from the message of the physical random access channel procedure (PRACH) both when wake up signaling detection is to be enabled at the wireless terminal and when wake up signaling detection is to be disabled at the wireless terminal. For example, upon first reception of the message of the physical random access channel procedure (PRACH), the PRACH-based wake up signaling state controller 30(25) may determine that the wake up signaling detection is to be enabled. Subsequently, upon a further reception of the message of the physical random access channel procedure (PRACH), the PRACH-based wake up signaling state controller 30(25) may determine that the wake up signaling detection is to be disabled.

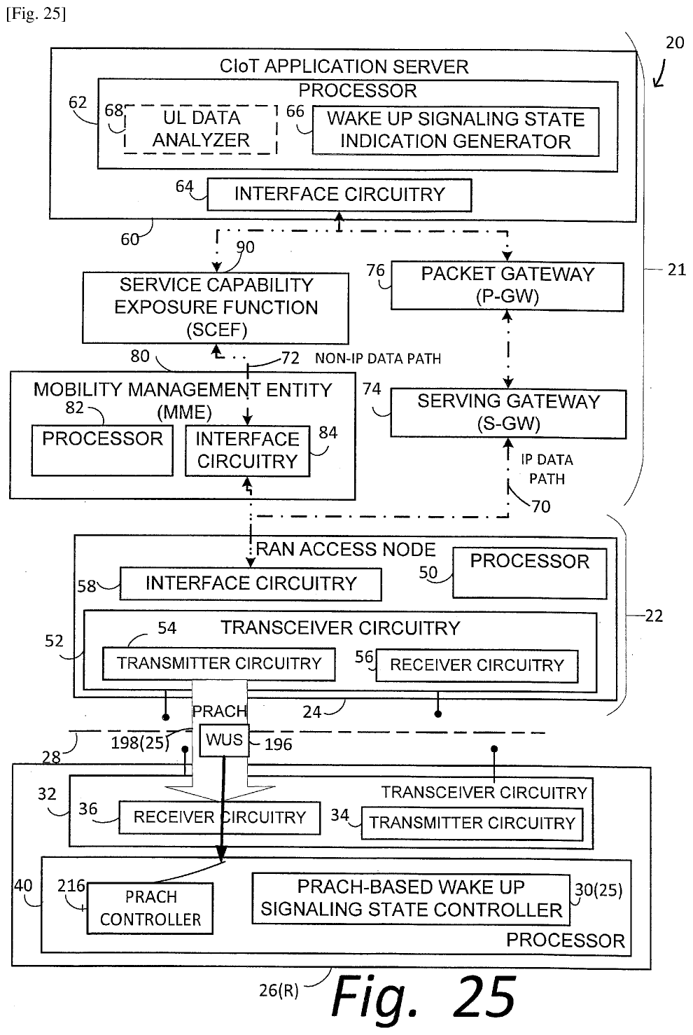

FIG. 26 shows example, representative, basic acts or steps performed by the wireless terminal 26(25) of FIG. 25 in an example mode. Act 26-1 comprises obtaining the message of the physical random access channel procedure over the radio interface. Act 26-2 comprises determining, from the message of the physical random access channel procedure, both when wake up signaling detection is to be enabled at the wireless terminal and when wake up signaling detection is to be disabled at the wireless terminal. Act 26-3 comprises operating the wake up signaling detection for the wireless terminal in accordance with the received message of the physical random access channel procedure.

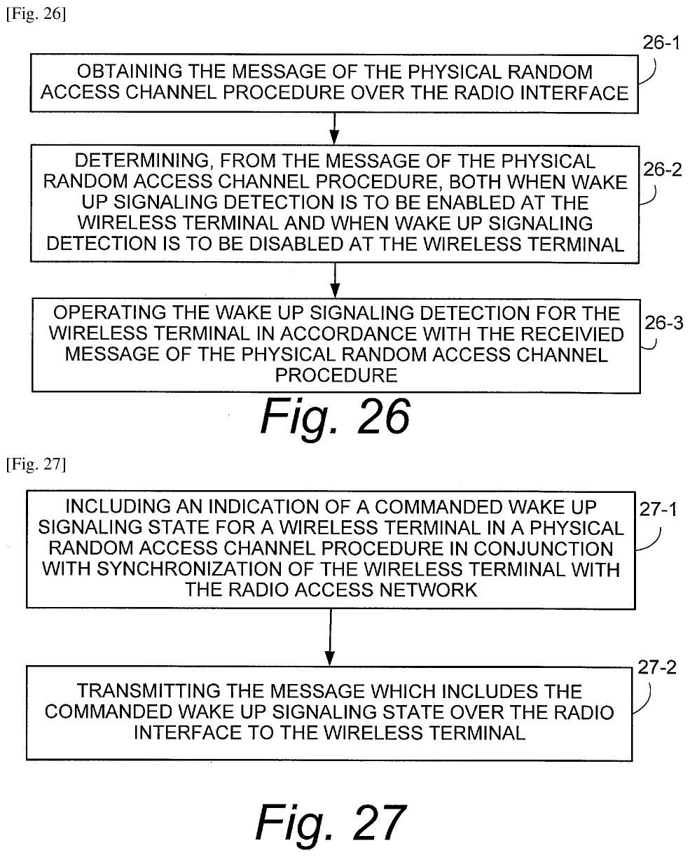

FIG. 27 shows example, representative, basic acts or steps performed by a network node of FIG. 25 in an example mode. Act 27-1 comprises including an indication of a commanded wake up signaling state for a wireless terminal in a physical random access channel procedure in conjunction with synchronization of the wireless terminal with the radio access network. Act 27-2 comprises transmitting the message which includes the commanded wake up signaling state over the radio interface to the wireless terminal.

In the example implementation of the embodiment and mode of FIG. 20 and FIG. 21, the PRACH-based wake up signaling state controller 30(25) determines that wake up signaling detection is to be enabled at the wireless terminal when the message of the physical random access channel procedure has a first value (e.g., a 1 value) and determines that wake up signaling detection is to be disabled at the wireless terminal when a second reception of the same the message of the physical random access channel procedure has a second value (e.g., a 0 value). The assigment of 0 or 1 for the bit for enablement and disablement may, of course, be reversed if desired.

During (N)PRACH procedures after wireless terminal 26(25) is synchronized to the network, the wireless terminal needs to keep uplink timing synchronization through obtaining timing advance (TA) command from the eNB/gNB, so the WUS enable/disable information can be delivered to the wireless terminal 26(25) in PRACH procedures, e.g., through 1 bit information (0 and 1, representing enable and disable, or disable and disable respectively) carried by Msg2 or Msg4. In this alternative design, the network can configure WUS detection wireless terminal by wireless terminal. In other words, the indication of a commanded wake up signaling state for the wireless terminal included in the PRACH message is specifically intended for a particular wireless terminal as opposed to other wireless terminals that also may be seeking network access.

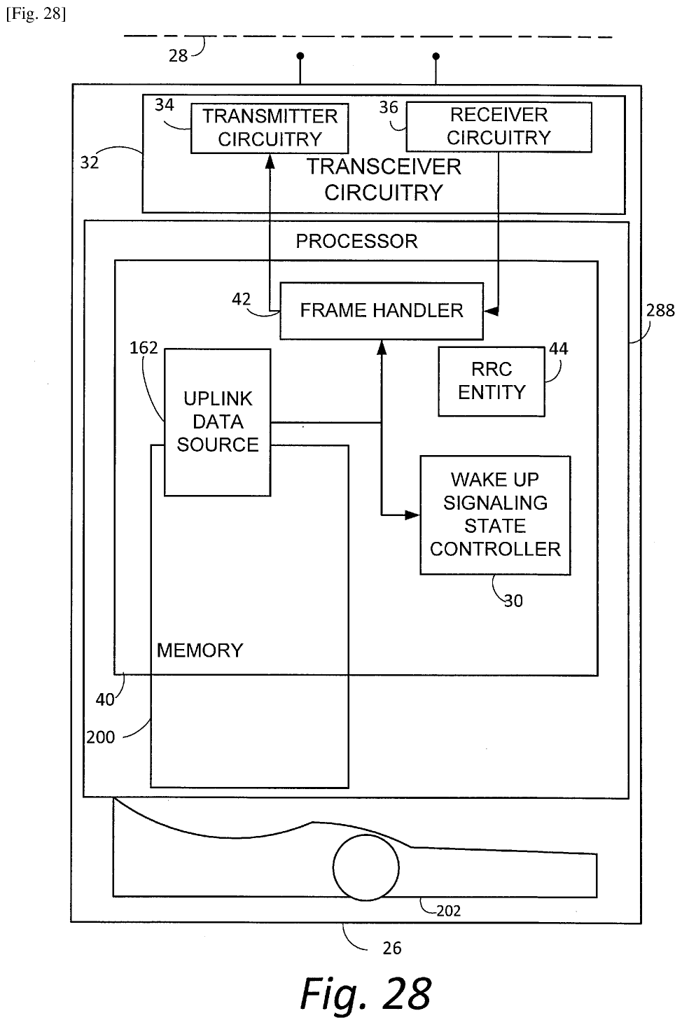

FIG. 28 shows other possible components and functionalities of wireless terminal 26 in various example embodiments and modes. In addition to terminal processor circuitry 40, wireless terminal 26 also comprises terminal memory 200, e.g., memory circuitry, which may store an operating system and various application programs. The memory 200 may be any suitable type of memory, e.g., random access memory (RAM), read only memory (ROM), cache memory, processor register memory, or any combination of one or more memory types. The applications comprising instructions executable by processor circuitry 40 and are stored in non-transient portions of terminal memory 200. At least some aspects of terminal memory 200 may also be considered as part of wake up signaling state controller 30. The wireless terminal 26 may also comprise a source of uplink data 162. The uplink data transmitted on non-IP data path 72 may be generated by processor 40 and/or stored in terminal memory 200.

In at least some example embodiments and modes, e.g., more sophisticated embodiment and modes, user equipment 26 may further comprise terminal user interface(s) 202. The user interfaces 202 may comprise one or more suitable input/output devices which are operable by a user. Some of all of the user interfaces 202 may be realized by a touch sensitive screen. The user interface(s) 64 may also comprise a keyboard, audio input and output, and other user I/O devices. Only a portion of the user interfaces 202 is depicted in Fig. UE, it being understood that the user interfaces 202 may be provided on a cover or case of wireless terminal 26 and thus may visibly obscure the underlying other components shown in Fig. UE.

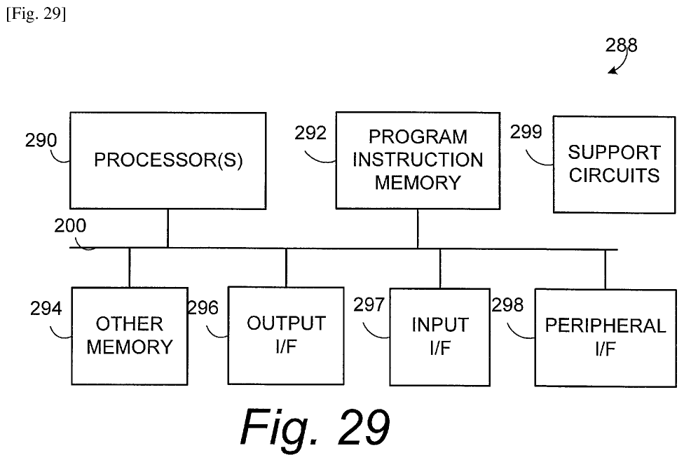

Certain units and functionalities of wireless terminal 26, or of any of the core network nodes, such as mobility management entity (MME) 80, Service Capability Exposure Function (SCEF) 90, and CIoT application server 60, may be implemented by terminal electronic machinery 288. FIG. 29 shows an example of such electronic machinery as comprising one or more processors 290, program instruction memory 292; other memory 294 (e.g., RAM, cache, etc.); input/output interfaces 296 and 297, peripheral interfaces 298; support circuits 299; and busses 300 for communication between the aforementioned units. The processor(s) 290 may comprise the processor circuitries described herein, for example, the terminal processor 40 of user equipment 26, the node processor circuitry 50 of access node 24, application server processor 62 of CIoT application server 60, and/or MME processor circuitry 82 of mobility management entity (MME) 80.

The memory 294, or computer-readable medium, may be one or more of readily available memory such as random access memory (RAM), read only memory (ROM), floppy disk, hard disk, flash memory or any other form of digital storage, local or remote, and is preferably of non-volatile nature, as and such may comprise memory 200. The support circuits 299 are coupled to the processors 290 for supporting the processor in a conventional manner. These circuits include cache, power supplies, clock circuits, input/output circuitry and subsystems, and the like.

Although the processes and methods of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein may additionally be considered to be embodied entirely within any form of computer-readable memory, such as solid-state memory, magnetic disk, or optical disk containing an appropriate set of computer instructions that would cause a processor to carry out the techniques described herein.

Moreover, each functional block or various features of the user equipment 26 used in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

One or more features of the example embodiments and modes described herein may be used in conjunction with one or more other features, in any combination.

The technology disclosed herein thus comprises and compasses the following non-exhaustive example embodiments and modes:

Example Embodiment 1: A wireless terminal which communicates over a radio interface with a radio access network, the wireless terminal comprising: receiver circuitry configured to obtain, in a message received over the radio interface when the wireless terminal is in a connected mode, an indication from a core network of a commanded wake up signaling state for the wireless terminal; processor circuitry configured to manage a current wake up signaling state of the wireless terminal in the connected mode as being either in an enable wake up signaling state or a disable wake up signaling state in dependence upon the commanded wake up signaling state indicated by the core network.

Example Embodiment 2: The wireless terminal of claim Example Embodiment 1, wherein when the wireless terminal is one of an enhanced machine-type communication device and a narrow band Internet of Things device.

Example Embodiment 3: The wireless terminal of claim Example Embodiment 1, wherein when the current wake up signaling state is the enable wake up signaling state the receiver circuitry of the wireless terminal is configured to monitor for receipt of a wake up signal; wherein in response to receipt of the wake up signal the receiver circuitry is configured to monitor for receipt of a paging message; wherein when the current wake up signaling state is the disable wake up signaling state the receiver circuitry does not monitor for the wake up signal and the wireless terminal operates with lower power than when configured to monitor for receipt of the wake up signal.

Example Embodiment 4: The wireless terminal of Example Embodiment 1, further comprising transmitter circuitry configured to transmit uplink data configured to be used by the core network to generate the indication.

Example Embodiment 5: The wireless terminal of Example Embodiment 1, wherein the indication of the commanded wake up signaling state for the wireless terminal has been generated by an application server and routed though the core network and the radio access network to the wireless terminal.

Example Embodiment 6: The wireless terminal of claim Example Embodiment 5, wherein the indication of the commanded wake up signaling state for the wireless terminal has been routed though a Service Capability Exposure Function, SCEF, and a Mobility Management Entity, MME, of the core network.

Example Embodiment 7: The wireless terminal of Example Embodiment 1, wherein the message received over the radio interface is a non-access stratum detach request message comprising the indication from the core network of the commanded wake up signaling state for the wireless terminal.

Example Embodiment 8: The wireless terminal of Example Embodiment 1, wherein the message received over the radio interface is a downlink information transfer message which at least partially encapsulates a non-access stratum message, and wherein the non-access stratum message in turn comprises the indication from the core network of the commanded wake up signaling state for the wireless terminal.

Example Embodiment 9: The wireless terminal of Example Embodiment 1, wherein the message received over the radio interface is a radio resource control connection release message which at least partially includes a UE context release message, and wherein the UE context release message in turn comprises the indication from the core network of the commanded wake up signaling state for the wireless terminal.

Example Embodiment 10: The wireless terminal of Example Embodiment 1, wherein the message received over the radio interface is a tracking/routing area update accept response message which comprises the indication from the core network of the commanded wake up signaling state for the wireless terminal.

Example Embodiment 11: A method in a wireless terminal which communicates over a radio interface with a radio access network, the method comprising: obtaining, in a message received over the radio interface when the wireless terminal is in a connected mode, an indication from a core network of a commanded wake up signaling state for the wireless terminal; using processor circuitry to manage a current wake up signaling state of the wireless terminal in the connected mode as being either in an enable wake up signaling state or a disable wake up signaling state in dependence upon the commanded wake up signaling state indicated by the core network.

Example Embodiment 12: The method of claim Example Embodiment 11, wherein when the wireless terminal is one of an enhanced machine-type communication device and a narrow band Internet of Things device.

Example Embodiment 13: The method of Example Embodiment 11, wherein when the current wake up signaling state is the enable wake up signaling state the receiver circuitry of the wireless terminal is configured to monitor for receipt of a wake up signal; wherein in response to receipt of the wake up signal the receiver circuitry is configured to monitor for receipt of a paging message; wherein when the current wake up signaling state is the disable wake up signaling state the receiver circuitry does not monitor for the wake up signal and the wireless terminal operates with lower power than when configured to monitor for receipt of the wake up signal.

Example Embodiment 14: The method of Example Embodiment 11, further comprising transmitting uplink data configured to be used by the core network to generate the indication.

Example Embodiment 15: The method of Example Embodiment 13, wherein the indication of the commanded wake up signaling state for the wireless terminal has been generated by an application server and routed though the core network and the radio access network to the wireless terminal.

Example Embodiment 16: The method of Example Embodiment 15, wherein the indication of the commanded wake up signaling state for the wireless terminal has been routed though a Service Capability Exposure Function, SCEF, and a Mobility Management Entity, MME, of the core network.

Example Embodiment 17: The method of Example Embodiment 13, wherein the message received over the radio interface is a non-access stratum detach request message comprising the indication from the core network of the commanded wake up signaling state for the wireless terminal.

Example Embodiment 18: The method of Example Embodiment 13, wherein the message received over the radio interface is a downlink information transfer message which at least partially encapsulates a non-access stratum message, and wherein the non-access stratum message in turn comprises the indication from the core network of the commanded wake up signaling state for the wireless terminal.

Example Embodiment 19: The method of Example Embodiment 13, wherein the message received over the radio interface is a radio resource control connection release message which at least partially includes a UE context release message, and wherein the UE context release message in turn comprises the indication from the core network of the commanded wake up signaling state for the wireless terminal.

Example Embodiment 20: The method of Example Embodiment 19, wherein the message received over the radio interface is a tracking/routing area update accept response message which comprises the indication from the core network of the commanded wake up signaling state for the wireless terminal.

Example Embodiment 21: A node of a core network of a telecommunications system, the core network node comprising: processor circuitry configured to include an indication of a commanded wake up signaling state for a wireless terminal in a message, the commanded wake up signaling state being either an enable wake up signaling state or a disable wake up signaling state; interface circuitry configured to transmit the message to a radio access network which serves the wireless terminal.

Example Embodiment 22: The core network node of Example Embodiment 21, wherein the processor circuitry is configured to include the indication of the commanded wake up signaling state in a non-access stratum message.

Example Embodiment 23: The core network node of Example Embodiment 22, wherein the processor circuitry is configured to include the indication of the commanded wake up signaling state in a downlink information transport message.

Example Embodiment 24: The core network node of Example Embodiment 22, wherein the processor circuitry is configured to include the indication of the commanded wake up signaling state in a non-access stratum detach message.

Example Embodiment 25: The core network node of Example Embodiment 21, wherein the processor circuitry is configured to include the indication of the commanded wake up signaling state in a radio resource control message.

Example Embodiment 26: The core network node of Example Embodiment 25, wherein the processor circuitry is configured to include the indication of the commanded wake up signaling state in a radio resource control connection release message.

Example Embodiment 27: The core network node of Example Embodiment 25, wherein the processor circuitry is configured to include the indication of the commanded wake up signaling state in an area update accept message.

Example Embodiment 28: A node of a core network of a telecommunications system, the core network node comprising: processor circuitry configured to generate an indication of a commanded wake up signaling state for a wireless terminal in a message, the commanded wake up signaling state being either an enable wake up signaling state or a disable wake up signaling state; interface circuitry configured to transmit the message toward a radio access network which serves the wireless terminal.

Example Embodiment 29: The core network node of Example Embodiment 28, wherein the processor circuitry is configured to generate the indication of the commanded wake up signaling state in a non-access stratum message at least partially on a basis of uplink data received from the wireless terminal by the core node.

Example Embodiment 30: A method in a node of a core network of a telecommunications system, the method comprising: using processor circuitry to include an indication of a commanded wake up signaling state for a wireless terminal in a message, the commanded wake up signaling state being either an enable wake up signaling state or a disable wake up signaling state; transmitting the message to a radio access network which serves the wireless terminal.

Example Embodiment 31: The method of Example Embodiment 30, further comprising the processor circuitry including the indication of the commanded wake up signaling state in a non-access stratum message.

Example Embodiment 32: The method of Example Embodiment 31, further comprising the processor circuitry including the indication of the commanded wake up signaling state in a downlink information transport message.

Example Embodiment 33: The method of Example Embodiment 31, further comprising the processor circuitry including the indication of the commanded wake up signaling state in a non-access stratum detach message.

Example Embodiment 34: The method of Example Embodiment 30, further comprising the processor circuitry including the indication of the commanded wake up signaling state in a radio resource control message.

Example Embodiment 35: The method of Example Embodiment 34, further comprising the processor circuitry including the indication of the commanded wake up signaling state in a radio resource control connection release message.

Example Embodiment 36: The method of Example Embodiment 34, further comprising the processor circuitry including the indication of the commanded wake up signaling state in an area update accept message.

Example Embodiment 37: A method in a node of a core network of a telecommunications system, the method comprising: using processor circuitry to generate an indication of a commanded wake up signaling state for a wireless terminal in a message, the commanded wake up signaling state being either an enable wake up signaling state or a disable wake up signaling state; transmitting the message toward a radio access network which serves the wireless terminal.

Example Embodiment 38: The method of Example Embodiment 37, further comprising the processor circuitry generating the indication of the commanded wake up signaling state in a non-access stratum message at least partially on a basis of uplink data received from the wireless terminal by the core node.

Example Embodiment 39: A wireless terminal which communicates over a radio interface with a radio access network, the wireless terminal comprising: receiver circuitry configured to obtain, over the radio interface, wake up signaling state information for the wireless terminal, the wake up signaling state information indicating a commanded wake up signaling state for the wireless terminal, the commanded wake up signaling state being either (1) that wake up signal detection is to be enabled at the wireless terminal, or (2) that wake up signal detection is to be disabled at the wireless terminal; processor circuitry configured, upon reception of the wake up signaling state information, to enter the commanded wake up signaling state indicated by the wake up signaling state information and to remain in the commanded wake up signaling state for a configured duration; and upon reaching the configured duration, to transition to a non-commanded wake up signaling state.

Example Embodiment 40: The wireless terminal of Example Embodiment 39, wherein the configured duration corresponds to a time period until which the wireless terminal detects a predetermined number of wake up signals.

Example Embodiment 41: The wireless terminal of Example Embodiment 39, wherein the configured duration corresponds a predetermined number of LTE extended discontinuous reception (eDRX) cycles.

Example Embodiment 42: The wireless terminal of Example Embodiment 39, wherein the configured duration corresponds a predetermined time window.

Example Embodiment 43: The wireless terminal of Example Embodiment 39, wherein the configured duration corresponds expiration of a timer set to the configured duration.

Example Embodiment 44: The wireless terminal of Example Embodiment 39, wherein the configured duration is pre-configured in memory of the wireless terminal.

Example Embodiment 45: The wireless terminal of Example Embodiment 39, wherein the configured duration is pre-configured in memory of the wireless terminal.

Example Embodiment 46: The wireless terminal of Example Embodiment 39, wherein the configured duration is configured in memory of the wireless terminal by a signal received over the radio interface.

Example Embodiment 47: The wireless terminal of Example Embodiment 46, wherein the configured duration is configured in memory of the wireless terminal by a medium access control control element.

Example Embodiment 48: The wireless terminal of Example Embodiment 46, wherein the configured duration is configured in memory of the wireless terminal by a system information block.

Example Embodiment 49: The wireless terminal of Example Embodiment 46, wherein the configured duration is configured in memory of the wireless terminal by a dedicated radio resource control signaling.

Example Embodiment 50: The wireless terminal of Example Embodiment 39, wherein the commanded wake up signaling state received by the receiver is only one of (1) that wake up signal detection is to be enabled at the wireless terminal, or (2) that wake up signal detection is to be disabled at the wireless terminal, and wherein the non-commanded wake up signaling state is the other of (1) and (2).

Example Embodiment 51: A method in a wireless terminal which communicates over a radio interface with a radio access network, the method comprising: obtaining, over the radio interface, wake up signaling state information for the wireless terminal, the wake up signaling state information indicating a commanded wake up signaling state for the wireless terminal, the commanded wake up signaling state being either (1) that wake up signal detection is to be enabled at the wireless terminal, or (2) that wake up signal detection is to be disabled at the wireless terminal; upon reception of the wake up signaling state information, entering the commanded wake up signaling state indicated by the wake up signaling state information; remaining in the commanded wake up signaling state for a configured duration; and upon reaching the configured duration, transitioning to a non-commanded wake up signaling state.

Example Embodiment 52: The method of Example Embodiment 51, wherein the configured duration corresponds to a time period until which the wireless terminal detects a predetermined number of wake up signals.

Example Embodiment 53: The method of Example Embodiment 51, wherein the configured duration corresponds a predetermined number of LTE extended discontinuous reception (eDRX) cycles.

Example Embodiment 54: The method of Example Embodiment 51, wherein the configured duration corresponds a predetermined time window.

Example Embodiment 55: The method of Example Embodiment 51, wherein the configured duration corresponds expiration of a timer set to the configured duration.

Example Embodiment 56: The method of Example Embodiment 51, wherein the configured duration is pre-configured in memory of the wireless terminal.

Example Embodiment 57: The method of Example Embodiment 51, wherein the configured duration is pre-configured in memory of the wireless terminal.

Example Embodiment 58: The method of Example Embodiment 51, wherein the configured duration is configured in memory of the wireless terminal by a signal received over the radio interface.

Example Embodiment 59: The method of Example Embodiment 58, wherein the configured duration is configured in memory of the wireless terminal by a medium access control control element.

Example Embodiment 60: The method of Example Embodiment 58, wherein the configured duration is configured in memory of the wireless terminal by a system information block.

Example Embodiment 61: The method of Example Embodiment 58, wherein the configured duration is configured in memory of the wireless terminal by a dedicated radio resource control signaling.

Example Embodiment 62: The method of Example Embodiment 51, wherein the commanded wake up signaling state received by the receiver is only one of (1) that wake up signal detection is to be enabled at the wireless terminal, or (2) that wake up signal detection is to be disabled at the wireless terminal, and wherein the non-commanded wake up signaling state is the other of (1) and (2).

Example Embodiment 63: A node of a radio access network which communicates over a radio interface with a wireless terminal, the network node comprising: processor circuitry configured to include an indication of a commanded wake up signaling state for a wireless terminal in a message, the commanded wake up signaling state being just one of an enable wake up signaling state or a disable wake up signaling state; transmitter circuitry configured to transmit a message which includes the commanded wake up signaling state over the radio interface to the wireless terminal.

Example Embodiment 64: The node of Example Embodiment 63, wherein the processor circuitry is further configured to generate a configuration message which includes an indication of a configured duration for which the wireless terminal is required to remain in the commanded wake up signaling state before transitioning to a non-commanded wake up signaling state.

Example Embodiment 65: The node of Example Embodiment 64, wherein the configuration message comprises a medium access control (MAC) control element (CE).

Example Embodiment 66: The node of Example Embodiment 64, wherein the configuration message comprises a system information block (SIB).

Example Embodiment 67: The node of Example Embodiment 64, wherein the configuration message comprises a dedicated radio resource control message.

Example Embodiment 68: The node of Example Embodiment 63, wherein the wireless terminal by default operates in an enable wake up signaling state, and wherein the commanded wake up signaling state is a disable wake up signaling state.

Example Embodiment 69: A method in a node of a radio access network which communicates over a radio interface with a wireless terminal, the method comprising: using processor circuitry to include an indication of a commanded wake up signaling state for a wireless terminal in a message, the commanded wake up signaling state being just one of an enable wake up signaling state or a disable wake up signaling state; transmitting a message which includes the commanded wake up signaling state over the radio interface to the wireless terminal.

Example Embodiment 70: The method of Example Embodiment 69, wherein the processor circuitry is further configured to generate a configuration message which includes an indication of a configured duration for which the wireless terminal is required to remain in the commanded wake up signaling state before transitioning to a non-commanded wake up signaling state.

Example Embodiment 71: The method of Example Embodiment 69, wherein the configuration message comprises a medium access control (MAC) control element (CE).

Example Embodiment 72: The method of Example Embodiment 69, wherein the configuration message comprises a system information block (SIB).

Example Embodiment 73: The method of Example Embodiment 69, wherein the configuration message comprises a dedicated radio resource control message.

Example Embodiment 74: The method Example Embodiment 69, wherein the wireless terminal by default operates in an enable wake up signaling state, and wherein the commanded wake up signaling state is a disable wake up signaling state.

Example Embodiment 75: A wireless terminal which communicates over a radio interface with a radio access network, the wireless terminal comprising: receiver circuitry configured to obtain, over the radio interface, wake up signaling state information for the wireless terminal, the wake up signaling state information indicating a commanded wake up signaling state for the wireless terminal, the commanded wake up signaling state being that wake up signal detection is to be disabled at the wireless terminal; processor circuitry configured: to operate the wireless terminal in a default wake up signaling state wherein wake up signal detection is enabled, and upon reception of the wake up signaling state information, to enter the commanded wake up signaling state and thereby disable the wake up signal detection for a configured duration.

Example Embodiment 76: The wireless terminal of Example Embodiment 75, wherein the processor circuitry is further configured to return to the default wake up signaling state after the configured duration.

Example Embodiment 77: The wireless terminal of Example Embodiment 75, wherein the configured duration corresponds to a time period until which the wireless terminal detects a predetermined number of wake up signals.

Example Embodiment 78: The wireless terminal of Example Embodiment 75, wherein the configured duration corresponds a predetermined number of LTE extended discontinuous reception (eDRX) cycles.

Example Embodiment 79: The wireless terminal of Example Embodiment 75, wherein the configured duration corresponds a predetermined time window.

Example Embodiment 80: The wireless terminal of Example Embodiment 75, wherein the configured duration corresponds expiration of a timer set to the configured duration.

Example Embodiment 81: The wireless terminal of Example Embodiment 75, wherein the configured duration is pre-configured in memory of the wireless terminal.

Example Embodiment 82: The wireless terminal of Example Embodiment 75, wherein the configured duration is pre-configured in memory of the wireless terminal.

Example Embodiment 83: The wireless terminal of Example Embodiment 75, wherein the configured duration is configured in memory of the wireless terminal by a signal received over the radio interface.

Example Embodiment 84: The wireless terminal of Example Embodiment 83, wherein the configured duration is configured in memory of the wireless terminal by a medium access control control element.

Example Embodiment 85: The wireless terminal of Example Embodiment 83, wherein the configured duration is configured in memory of the wireless terminal by a system information block.

Example Embodiment 86: The wireless terminal of Example Embodiment 83, wherein the configured duration is configured in memory of the wireless terminal by a dedicated radio resource control signaling.

Example Embodiment 87: A wireless terminal which communicates over a radio interface with a radio access network, the wireless terminal comprising: receiver circuitry configured to obtain medium access control (MAC) control elements (CE) over the radio interface; processor circuitry configured to determine from the medium access control (MAC) control elements (CE) both when wake up signaling detection is to be enabled at the wireless terminal and when wake up signaling detection is to be disabled at the wireless terminal.

Example Embodiment 88: The wireless terminal of Example Embodiment 87, wherein the processor circuitry is configured to determine that wake up signaling detection is to be enabled at the wireless terminal when a particular medium access control (MAC) control element (CE) has a first value and to determine that wake up signaling detection is to be disabled at the wireless terminal when a particular medium access control (MAC) control element (CE) has a second value.

Example Embodiment 89: The wireless terminal of Example Embodiment 87, wherein the processor circuitry is configured to operate the wake up signaling detection for the wireless terminal in accordance with a received medium access control (MAC) control elements (CE).

Example Embodiment 90: A method in a wireless terminal which communicates over a radio interface with a radio access network, the method comprising: obtaining medium access control (MAC) control elements (CE) over the radio interface; using processor circuitry to determine from the medium access control (MAC) control elements (CE) both when wake up signaling detection is to be enabled at the wireless terminal and when wake up signaling detection is to be disabled at the wireless terminal.

Example Embodiment 91: The method of Example Embodiment 90, further comprising determining that wake up signaling detection is to be enabled at the wireless terminal when a particular medium access control (MAC) control element (CE) has a first value and determining that wake up signaling detection is to be disabled at the wireless terminal when a particular medium access control (MAC) control element (CE) has a second value.

Example Embodiment 92: The method of Example Embodiment 90, further comprising operating the wake up signaling detection for the wireless terminal in accordance with a received medium access control (MAC) control elements (CE).

Example Embodiment 93: A wireless terminal which communicates over a radio interface with a radio access network, the wireless terminal comprising: receiver circuitry configured to obtain broadcasted system information over the radio interface; processor circuitry configured to determine from the broadcasted system information both when wake up signaling detection is to be enabled at the wireless terminal and when wake up signaling detection is to be disabled at the wireless terminal.

Example Embodiment 94: The wireless terminal of Example Embodiment 93, wherein the processor circuitry is configured to determine that wake up signaling detection is to be enabled at the wireless terminal when a particular system information block (SIB) has a first value and to determine that wake up signaling detection is to be disabled at the wireless terminal when the particular system information block (SIB) has a second value.

Example Embodiment 95: The wireless terminal of Example Embodiment 93, wherein the processor circuitry is configured to operate the wake up signaling detection for the wireless terminal in accordance with received broadcasted system information.

Example Embodiment 96: A method in a wireless terminal which communicates over a radio interface with a radio access network, the method comprising: obtaining broadcasted system information over the radio interface; using processor circuitry to determine from the broadcasted system information both when wake up signaling detection is to be enabled at the wireless terminal and when wake up signaling detection is to be disabled at the wireless terminal.

Example Embodiment 97: The method of Example Embodiment 96, further comprising determining that wake up signaling detection is to be enabled at the wireless terminal when a particular system information block (SIB) has a first value and determining that wake up signaling detection is to be disabled at the wireless terminal when the particular system information block (SIB) has a second value.

Example Embodiment 98: The method of Example Embodiment 96, further comprising operating the wake up signaling detection for the wireless terminal in accordance with received broadcasted system information.

Example Embodiment 99: A wireless terminal which communicates over a radio interface with a radio access network, the wireless terminal comprising: receiver circuitry configured to obtain paging downlink control information over the radio interface; processor circuitry configured to determine from the paging downlink control information both when wake up signaling detection is to be enabled at the wireless terminal and when wake up signaling detection is to be disabled at the wireless terminal.

Example Embodiment 100: The wireless terminal of Example Embodiment 99, wherein the processor circuitry is configured to determine that wake up signaling detection is to be enabled at the wireless terminal when the paging downlink control information has a first value and to determine that wake up signaling detection is to be disabled at the wireless terminal when the paging downlink control information has a second value.

Example Embodiment 101: The wireless terminal of Example Embodiment 99, wherein the processor circuitry is configured to operate the wake up signaling detection for the wireless terminal in accordance with received paging downlink control information.

Example Embodiment 102: A method in a wireless terminal which communicates over a radio interface with a radio access network, the method comprising: obtaining paging downlink control information over the radio interface; using processor circuitry to determine from the paging downlink control information both when wake up signaling detection is to be enabled at the wireless terminal and when wake up signaling detection is to be disabled at the wireless terminal.

Example Embodiment 103: The method of Example Embodiment 102, further comprising determining that wake up signaling detection is to be enabled at the wireless terminal when the paging downlink control information has a first value and determining that wake up signaling detection is to be disabled at the wireless terminal when the paging downlink control information has a second value.

Example Embodiment 104: The method of Example Embodiment 102, further comprising operating the wake up signaling detection for the wireless terminal in accordance with received paging downlink control information.

Example Embodiment 105: A wireless terminal which communicates over a radio interface with a radio access network, the wireless terminal comprising: receiver circuitry configured to obtain, over the radio interface: medium access control (MAC) control elements (CE); broadcasted system information; paging downlink control information; processor circuitry configured: to make a first determination when wake up signaling detection is to be enabled at the wireless terminal using at least one of the medium access control (MAC) control element (CE), the broadcasted system information, and the paging downlink control information; and to make a second determination when wake up signaling detection is to be disabled at the wireless terminal using at least one of the medium access control (MAC) control element (CE), the broadcasted system information, and the paging downlink control information.

Example Embodiment 106: The wireless terminal of Example Embodiment 105, wherein the processor circuitry is configured to operate the wake up signaling detection in accordance with the determinations.

Example Embodiment 107: The wireless terminal of Example Embodiment 105, wherein the processor circuitry is configured to make both the first determination and the second determination using a same one of the medium access control (MAC) control element (CE), the broadcasted system information, and the paging downlink control information.

Example Embodiment 108: The wireless terminal of Example Embodiment 105, wherein when plural ones of the medium access control (MAC) control element (CE), the broadcasted system information, and the paging downlink control information include information affecting the wake up signaling detection, the processor circuitry is configured to select one of the medium access control (MAC) control element (CE), the broadcasted system information, and the paging downlink control information for use in operating the wake up signaling detection.

Example Embodiment 109: The wireless terminal of Example Embodiment 108, the processor circuitry is configured to select one of the medium access control (MAC) control element (CE), the broadcasted system information, and the paging downlink control information for use in making the first determination based on a prioritization of the medium access control (MAC) control element (CE), the broadcasted system information, and the paging downlink control information.

Example Embodiment 110: A method in a wireless terminal which communicates over a radio interface with a radio access network, the method comprising: obtaining, over the radio interface: medium access control (MAC) control elements (CE); broadcasted system information; paging downlink control information; using processor circuitry: to make a first determination when wake up signaling detection is to be enabled at the wireless terminal using at least one of the medium access control (MAC) control element (CE), the broadcasted system information, and the paging downlink control information; and to make a second determination when wake up signaling detection is to be disabled at the wireless terminal using at least one of the medium access control (MAC) control element (CE), the broadcasted system information, and the paging downlink control information.

Example Embodiment 111: The method of Example Embodiment 110, further comprising operating the wake up signaling detection in accordance with the determinations.

Example Embodiment 112: The method of Example Embodiment 110, further comprising making both the first determination and the second determination using a same one of the medium access control (MAC) control element (CE), the broadcasted system information, and the paging downlink control information.

Example Embodiment 113: The method of Example Embodiment 110, wherein when plural ones of the medium access control (MAC) control element (CE), the broadcasted system information, and the paging downlink control information include information affecting the wake up signaling detection, the method further comprises selecting one of the medium access control (MAC) control element (CE), the broadcasted system information, and the paging downlink control information for use in operating the wake up signaling detection.

Example Embodiment 114: The method of Example Embodiment 113, further comprising select one of the medium access control (MAC) control element (CE), the broadcasted system information, and the paging downlink control information for use in making the first determination based on a prioritization of the medium access control (MAC) control element (CE), the broadcasted system information, and the paging downlink control information.

Example Embodiment 115: The method of Example Embodiment 110, wherein when plural ones of the medium access control (MAC) control element (CE), the broadcasted system information, and the paging downlink control information include information commanding disablement of the wake up signaling detection, the method further comprises selecting one of the medium access control (MAC) control element (CE), the broadcasted system information, and the paging downlink control information for use in making the second determination.

Example Embodiment 116: The method of Example Embodiment 115, further comprising selecting one of the medium access control (MAC) control element (CE), the broadcasted system information, and the paging downlink control information for use in making the second determination based on a prioritization of the medium access control (MAC) control element (CE), the broadcasted system information, and the paging downlink control information.

Example Embodiment 117: A wireless terminal which communicates over a radio interface with a radio access network, the wireless terminal comprising: receiver circuitry configured to receive, over the radio interface, a message of a physical random access channel procedure in conjunction with synchronization of the wireless terminal with the radio access network; processor circuitry configured to obtain, from the message of the physical random access channel procedure, an indication of a commanded wake up signaling state for the wireless terminal.

Example Embodiment 118: The wireless terminal of Example Embodiment 117, wherein the processor circuitry is further configured to operate the wireless terminal in the commanded wake up signaling state.

Example Embodiment 119: The wireless terminal of Example Embodiment 117, wherein the indication of the commanded wake up signaling state for the wireless terminal is a single bit of information, and wherein a first value of the single bit indicates that the commanded wake up state is that that wake up signal detection is to be enabled at the wireless terminal, and wherein a second value of the single bit indicates that wake up signal detection is to be disabled at the wireless terminal.

Example Embodiment 120: The wireless terminal of Example Embodiment 117, wherein the message is one of a Msg2 and a Msg4 of the physical random access channel procedure.

Example Embodiment 121: The wireless terminal of Example Embodiment 117, wherein the indication of a commanded wake up signaling state for the wireless terminal included in the message is specifically intended for the wireless terminal.

Example Embodiment 122: A method in a wireless terminal which communicates over a radio interface with a radio access network, the method comprising: receiving, over the radio interface, a message of a physical random access channel procedure in conjunction with synchronization of the wireless terminal with the radio access network; using processor circuitry to obtain, from the message of the physical random access channel procedure, an indication of a commanded wake up signaling state for the wireless terminal.

Example Embodiment 123: The method of Example Embodiment 122, further comprising operating the wireless terminal in the commanded wake up signaling state.

Example Embodiment 124: The method of Example Embodiment 122, wherein the indication of the commanded wake up signaling state for the wireless terminal is a single bit of information, and wherein a first value of the single bit indicates that the commanded wake up state is that that wake up signal detection is to be enabled at the wireless terminal, and wherein a second value of the single bit indicates that wake up signal detection is to be disabled at the wireless terminal.

Example Embodiment 125: The method of Example Embodiment 122, wherein the message is one of a Msg2 and a Msg4 of the physical random access channel procedure.

Example Embodiment 126: The method of Example Embodiment 122, wherein the indication of a commanded wake up signaling state for the wireless terminal included in the message is specifically intended for the wireless terminal.

Example Embodiment 127: A node of a radio access network which communicates over a radio interface with a wireless terminal, the network node comprising: processor circuitry configured to include an indication of a commanded wake up signaling state for a wireless terminal in a physical random access channel procedure in conjunction with synchronization of the wireless terminal with the radio access network; transmitter circuitry configured to transmit the message which includes the commanded wake up signaling state over the radio interface to the wireless terminal.

Example Embodiment 128: The node of Example Embodiment 127, wherein the indication of the commanded wake up signaling state for the wireless terminal is a single bit of information, and wherein a first value of the single bit indicates that the commanded wake up state is that that wake up signal detection is to be enabled at the wireless terminal, and wherein a second value of the single bit indicates that wake up signal detection is to be disabled at the wireless terminal.

Example Embodiment 129: The node of Example Embodiment 127, wherein the message is one of a Msg2 and a Msg4 of the physical random access channel procedure.

Example Embodiment 130: The node of Example Embodiment 127, wherein the indication of a commanded wake up signaling state for the wireless terminal included in the message is specifically intended for the wireless terminal.

Example Embodiment 131: A method in a node of a radio access network which communicates over a radio interface with a wireless terminal, the method comprising: using processor circuitry to include an indication of a commanded wake up signaling state for a wireless terminal in a physical random access channel procedure in conjunction with synchronization of the wireless terminal with the radio access network; transmitting the message which includes the commanded wake up signaling state over the radio interface to the wireless terminal.

Example Embodiment 132: The method of Example Embodiment 131, wherein the indication of the commanded wake up signaling state for the wireless terminal is a single bit of information, and wherein a first value of the single bit indicates that the commanded wake up state is that that wake up signal detection is to be enabled at the wireless terminal, and wherein a second value of the single bit indicates that wake up signal detection is to be disabled at the wireless terminal.

Example Embodiment 133: The method of Example Embodiment 131, wherein the message is one of a Msg2 and a Msg4 of the physical random access channel procedure.

Example Embodiment 134: The method of Example Embodiment 131, wherein the indication of a commanded wake up signaling state for the wireless terminal included in the message is specifically intended for the wireless terminal.

Example Embodiment 135: A wireless terminal which communicates over a radio interface with a radio access network, the wireless terminal comprising: receiver circuitry configured to receive a paging message over the radio interface; processor circuitry configured to obtain, from the paging message, an indication of a commanded wake up signaling state for the wireless terminal.

Example Embodiment 136: The wireless terminal of Example Embodiment 135, wherein the processor circuitry is configured to obtain the indication of a commanded wake up signaling state for the wireless terminal when at least a portion of the paging message is scrambled with a scrambling code associated with the wake up state signal for the wireless terminal.

Example Embodiment 137: The wireless terminal of Example Embodiment 136, wherein the scrambling code associated with the wake up state signal for the wireless terminal is wake up state paging radio network temporary identifier (P-RNTI′) that differs from a nominal paging radio network temporary identifier (P-RNTI′) for the wireless terminal.

Example Embodiment 138: The wireless terminal of Example Embodiment 135, wherein the processor circuitry is configured to interpret a paging message scrambled with the wake up state paging radio network temporary identifier (P-RNTI′) as indicating a transition/toggling between wake up signaling states.

Example Embodiment 139: The wireless terminal of Example Embodiment 135, wherein the processor circuitry is configured to ascertain the commanded wake up signaling state from a predetermined portion of the paging message scrambled with the wake up state paging radio network temporary identifier (P-RNTI′).

Example Embodiment 140: The wireless terminal of Example Embodiment 139, wherein the processor circuitry is configured to ascertain, by a predetermined value comprising the predetermined portion of the paging message scrambled with the wake up state paging radio network temporary identifier (P-RNTI′), whether the commanded wake up signaling state is that that wake up signal detection is to be enabled at the wireless terminal or that wake up signal detection is to be disabled at the wireless terminal.

Example Embodiment 141: A node of a radio access network which communicates over a radio interface with a wireless terminal, the network node comprising: processor circuitry configured to include an indication of a commanded wake up signaling state for a wireless terminal in a paging message to the wireless terminal; transmitter circuitry configured to transmit the paging message which includes the commanded wake up signaling state over the radio interface to the wireless terminal.

Example Embodiment 142: The node of Example Embodiment 141, wherein the processor circuitry is configured to include the indication of a commanded wake up signaling state for the wireless terminal and to scramble at least a portion of the paging message with a scrambling code associated with the wake up state signal for the wireless terminal.

Example Embodiment 143: The node of Example Embodiment 142, wherein the scrambling code associated with the wake up state signal for the wireless terminal is wake up state paging radio network temporary identifier (P-RNTI′) that differs from a nominal paging radio network temporary identifier (P-RNTI′) for the wireless terminal.

Example Embodiment 144: The node of Example Embodiment 143, wherein the paging message scrambled with the wake up state paging radio network temporary identifier (P-RNTI′) indicates a transition/toggling between wake up signaling states.

Example Embodiment 145: The node of Example Embodiment 143, wherein the processor circuitry is configured to include the commanded wake up signaling state in a predetermined portion of the paging message scrambled with the wake up state paging radio network temporary identifier (P-RNTI′).

Example Embodiment 146: The node of Example Embodiment 145, wherein the processor circuitry is configured to include a predetermined value to comprise the predetermined portion of the paging message encoded with the wake up state paging radio network temporary identifier (P-RNTI′), the predetermined value indicating whether the commanded wake up signaling state is that that wake up signal detection is to be enabled at the wireless terminal or that wake up signal detection is to be disabled at the wireless terminal.

It will be appreciated that the technology disclosed herein is directed to solving radio communications-centric issues and is necessarily rooted in computer technology and overcomes problems specifically arising in radio communications. Moreover, the technology disclosed herein improves basic function of a wireless terminal, e.g., a user equipment, a network node, and a base station, so that, for example, operation of these entities may occur more effectively by prudent use of radio resources, especially for wake up signaling monitoring and detection. For example, the technology disclosed herein enables the user equipment 26 to judiciously enabling and disable wake up signaling detection, particularly in view of quality of service and other concerns/issues.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” The above-described embodiments could be combined with one another. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims.

1. A wireless terminal which communicates over a radio interface with a radio access network, the wireless terminal comprising:
receiver circuitry configured to obtain, in a message received over the radio interface in a case that the wireless terminal is in a connected mode, an indication from a core network of a commanded wake up signaling state for the wireless terminal;
processor circuitry configured to manage a current wake up signaling state of the wireless terminal in the connected mode as being either in an enable wake up signaling state or a disable wake up signaling state in dependence upon the commanded wake up signaling state indicated by the core network.

2. The wireless terminal of claim 1,
wherein in a case that the current wake up signaling state is the enable wake up signaling state, the receiver circuitry of the wireless terminal is configured to monitor for receipt of a wake up signal;
wherein in response to receipt of the wake up signal the receiver circuitry is configured to monitor for receipt of a paging message;
wherein in a case that the current wake up signaling state is the disable wake up signaling state the receiver circuitry does not monitor for the wake up signal.

3. The wireless terminal of claim 1, wherein the message received over the radio interface is a non-access stratum detach request message comprising the indication from the core network of the commanded wake up signaling state for the wireless terminal.

4. A method in a wireless terminal which communicates over a radio interface with a radio access network, the method comprising:
obtaining, in a message received over the radio interface in a case that the wireless terminal is in a connected mode, an indication from a core network of a commanded wake up signaling state for the wireless terminal;
using processor circuitry to manage a current wake up signaling state of the wireless terminal in the connected mode as being either in an enable wake up signaling state or a disable wake up signaling state in dependence upon the commanded wake up signaling state indicated by the core network.

5. The method of claim 4,
wherein in a case that the current wake up signaling state is the enable wake up signaling state the receiver circuitry of the wireless terminal is configured to monitor for receipt of a wake up signal;
wherein in response to receipt of the wake up signal the receiver circuitry is configured to monitor for receipt of a paging message;
wherein in a case that the current wake up signaling state is the disable wake up signaling state the receiver circuitry does not monitor for the wake up signal.

6. The method of claim 4, wherein the message received over the radio interface is a non-access stratum detach request message comprising the indication from the core network of the commanded wake up signaling state for the wireless terminal.

7. A node of a core network of a telecommunications system, the core network node comprising:
processor circuitry configured to include an indication of a commanded wake up signaling state for a wireless terminal in a message, the commanded wake up signaling state being either an enable wake up signaling state or a disable wake up signaling state;
interface circuitry configured to transmit the message to a radio access network which serves the wireless terminal.

8. The core network node of claim 7, wherein the processor circuitry is configured to include the indication of the commanded wake up signaling state in a non-access stratum message.

9. The core network node of claim 8, wherein the processor circuitry is configured to include the indication of the commanded wake up signaling state in a radio resource control message.

10. The core network node of claim 8, wherein the processor circuitry is configured to include the indication of the commanded wake up signaling state in a radio resource control connection release message.

11. A method in a node of a core network of a telecommunications system, the method comprising:
using processor circuitry to include an indication of a commanded wake up signaling state for a wireless terminal in a message, the commanded wake up signaling state being either an enable wake up signaling state or a disable wake up signaling state;
transmitting the message to a radio access network which serves the wireless terminal.

12. The method of claim 11, further comprising the processor circuitry including the indication of the commanded wake up signaling state in a non-access stratum message.

13. A method in a node of a core network of a telecommunications system, the method comprising:
using processor circuitry to generate an indication of a commanded wake up signaling state for a wireless terminal in a message, the commanded wake up signaling state being either an enable wake up signaling state or a disable wake up signaling state;
transmitting the message toward a radio access network which serves the wireless terminal.

14. The method of claim 13, further comprising the processor circuitry generating the indication of the commanded wake up signaling state in a non-access stratum message at least partially on a basis of uplink data received from the wireless terminal by the core node.
